(19) United States
(12) Patent Application Publication
(10) Pub. No.: US 2011/0126119 A1
(43) Pub. Date: May 26, 2011

(54) CONTEXTUAL PRESENTATION OF INFORMATION

(76) Inventors: Daniel J. Young, Cleveland, OH (US); Andrew Craze, Shaker Heights, OH (US); Greyson Fischer, Massillon, OH (US); Brian Asquith, Cleveland, OH (US)

(21) Appl. No.: 12/722,577

(22) Filed: Mar. 12, 2010

Related U.S. Application Data
(60) Provisional application No. 61/263,309, filed on Nov. 20, 2009.

(51) Int. Cl. G06F 3/01

(52) U.S. Cl. 715/744

(57) ABSTRACT

The present invention relates to system and methodology to facilitate context determination of operation of a user device. Based upon the context determination information can be adjusted dynamically to enable all or part of the information to be displayed on the user device in a manner consistent with the determined context. A plurality of monitoring devices provide data regarding operation of the user device. The data can be analyzed to generate a context score from which operation of the user device can be accordingly conducted. Operation of the user device can facilitate inference of current activity, location, etc., of a user operating or employing the user device.

### CROSS-REFERENCE TO RELATED APPLICATIONS

This application claims priority to U.S. Provisional Patent Application Ser. No. 61/263,309, entitled “CONTEXTUAL FONT SIZING”, filed Nov. 20, 2009, the entirety of which is incorporated herein by reference.

### TECHNICAL FIELD

The subject specification relates generally to determining a context of operation of a device and controlling operation of the device based upon the context.

### BACKGROUND

With the global availability of digital devices, ubiquitous information networks such as the internet, and the advent of communication technologies such as wireless, satellite, and the like, a wealth of information is available to a person living in the digital age. Associated with the wealth of information is the plurality of ways in which the information, in its various forms, is presented to a user, and devices facilitating such presentation. Presentation devices range from a small graphical user interface (GUI) on a mobile device such as a cellphone, an e-book reader, to displaying of information in an aircraft cockpit, through to information displayed on a computer monitor in a hospital, etc.

How information is presented is of importance to engineers, technicians, and other specialists in such fields as system design and engineering, information technology, information graphics, and a whole plethora of technical disciplines involved in the processing and conveyance of information to a user.

Of concern to such engineers, technicians, etc., is the device on which the information is to be presented, and accordingly, how much information can be readily presented on the device. Information presentation concerns can include such issues as text font size, text color, placement on a presentation device, etc., leading to the development of programming languages and protocols focused on the control and display of information such as website design, e.g., Hypertext markup language (HTML), extensible markup language (XML), etc., or other display technique relevant to presenting information on a device. While constructing a website or other means for conveying information, a commonly asked question is how to present information to provide effective conveyance of the information to a recipient. Of concern is the effective communication of data, thereby allowing a user to derive and extract information substance that pertains to them from the plethora of information that is, and could be, presented.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

The disclosed innovation, in its various aspects, relates to operation of a user device based upon a determined context of operation of the user device. Context of operation relates to such factors as previous, current, and future activity of a user employing the user device, previous, current and future location of user device (and according location of a user of the user device), user identity, date/time of operation, information to be presented, information notification, and the like. Context of operation can be determined by a context determination component.

In one aspect presentation of information on a presentation component associated with the user device can be controlled and adjusted based upon the determined context of operation of the user device. In another aspect, a determined context of operation can be employed to control subsequent operation of a user device and components associated therewith. Operation of a user device can be dynamically responsive to a determined context, and accordingly an activity, location, and the like of a user can be inferred based upon the operation of the user device.

In one aspect, context determination can control the font size with which information is presented on a presentation device. In another example, context determination can control what and where on a presentation device information is presented. In another example, context determination can be employed to dynamically adjust presentation of information as a user switches from one activity to another.

Context determination can be employed by a variety of technologies facilitating operation and presentation of information on a user device. Standards, protocols, and specifications such as HTML, XML, and the like can be employed. How applications execute/operate/terminate on the user device can also be controlled based upon the context determination.

Context determination can also be employed to adjust operation of a user device based upon the operating environment of the user device. In a stable environment a plethora of information can be displayed on the user device. In unstable conditions, the amount of information can be reduced such that only essential information and/or parameters are presented to enable a user to focus on their tasks whilst undergoing the unstable conditions. Upon return to stable conditions, the plethora of information can be represented on the user device.

Context determination can be assisted by data generated by a variety of components monitoring operation of the user device. Such components can provide data regarding location, motion, direction, user proximity, light conditions, date and time of operation, temperature, pressure, and the like.

Context determination can also be based upon the urgency ascribed to information to be presented on a user device. For example, only display information flagged to be “urgent” or from a particular source.

Context determination can be performed by determining a “context score” for one or more sources of context information. One or more algorithms can be employed to facilitate in the provision of one or more “context score(s)”. A lookup table can be referenced to determine operating conditions (e.g., presentation parameters) for a user device based upon the determined “context score”. Further, various arithmetical techniques can be employed when determining the one or more context scores, where such techniques include factor weightings, scalar weightings, least squares, and the like.

Values obtained from the various components monitoring operation of a user device can be equalized such that even though different parameters are being monitored, e.g., velocity, temperature, location, light, direction, etc., and therefore have different units and magnitudes, the values can be equalized such that a range of values received from one monitoring component can be accorded a same degree of importance to an entirely disparate range of values received from another monitoring component.

Various “rules” can be employed to control how a user device operates and how information is presented thereon. The “rules” can include “rules” regarding operation of a user device based upon such factors as location, information filtering, notification of information presentation, and the like.

In a further aspect, RFID technologies can be employed to facilitate operation of a user device in accordance with a user associated with the RFID. In another aspect, RFID technologies can be employed to provide location zoning, thereby controlling execution, operation, and termination of applications and information presentation on the user device.

In one aspect, as information is presented on a presentation component, in the event that not all of the information can be display, a portion of the information can be extracted to facilitate presentation of the main aspects of the message and the gist of the message to be understood. The extraction process can be re-performed in the event of a new context being determined as well as when new information is available for presentation.

As information is presented on a presentation component, a preferred region can be marked to be displayed on the screen as font size increases, decreases. Further a point of focus can be selected about which reduction and enlargement of information scope is centered, e.g., as a website enlarges, reduces.

In another aspect, with a variation in determined distance between a user and a presentation device changes, there can be an according change in font size allowing information to be viewed over a range of distances.

Various examples are presented indicating how a context determination system can be incorporated into a user device and how the context determination system interacts with an operating system and applications running on a user device.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a system 100 for contextual presentation of information in accordance with various aspects.

FIG. 2 illustrates a system 200 facilitating determination of a users location, activity, etc., from which a context of how they may want to interact with a user device can be determined in accordance with various aspects.

FIG. 3 illustrates system 300 depicting various components of which a user device utilizing context determination may comprise, in accordance with various aspects.

FIG. 4 illustrates system 400 comprising various components which can be employed in a system facilitating context determination in accordance with various aspects.

FIG. 5 illustrates system 500 for context based information presentation based upon an associated radio frequency identification device in accordance with various aspects.

FIG. 6 illustrates system 600 comprising an operating system, applications and a context determination system, coupled to input and output components, according to various aspects.

FIG. 7 illustrates system 700 with an operating system having open and direct modification, according to various aspects.

FIG. 8 illustrates system 800 where context determination can be performed external to an operating system, according to various aspects.

FIG. 9 illustrates system 900 where context determination components supplement an operating system, according to various aspects.

FIG. 10 illustrates system 1000 employing a system-on-a-chip configuration, according to various aspects.

FIG. 11 depicts a methodology 1100 that can facilitate presentation of information on a presentation device based upon the context of operation of a user device, according to various aspects.

FIG. 12 depicts a methodology 1200 that can facilitate determination of a context score for operation of a user device, according to various aspects.

FIG. 13 depicts a methodology 1300 that can facilitate determination of what information is to be presented based on operation context of a user device, according to various aspects.

FIG. 14 depicts a methodology 1400 that can facilitate operation of a user device based upon user preferences, according to various aspects.

FIG. 15 depicts a methodology 1500 that can facilitate presentation of particular information on a user device, according to various aspects.

FIG. 16 depicts a methodology 1600 that can facilitate control of applications running on a device based upon operation context, according to various aspects.

FIG. 17 depicts a methodology 1700 that can facilitate context operation of a user device based upon an associated RFID, according to various aspects.

FIG. 18 illustrates an example of a schematic block diagram of a computing environment in accordance with various aspects.

FIG. 19 illustrates an example of a block diagram of a computer operable to execute the disclosed architecture.

### DETAILED DESCRIPTION

Aspects and embodiments of various innovations are now described with reference to the drawings, wherein like reference numerals are used to refer to like elements throughout. In the following description, for purposes of explanation, numerous specific details are set forth in order to provide a thorough understanding of the various innovations presented herein. It can be evident, however, that the various innovations can be practiced without these specific details. In other instances, well-known structures and devices are shown in block diagram form in order to facilitate describing the various innovative features

As used in this application, the terms “component”, “module”, “system”, “interface”, or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Traditional methods of presenting information on electronic devices often involves the information being presented in a fixed manner. Information can be rendered using HTML and other protocols and typically involves the information being presented at a fixed location on a display device with fixed font size, color, etc. For example, a text message presented on a cellphone display may be displayed on the screen in such a manner that for the user of the device to read the information they have to pause or curtail their current activity. For example, owing to a small text font size a user has to stop jogging to read an SMS displayed on their cellphone.

In another example, a short message service (SMS) message presented on a cellphone display, the SMS is displayed with a particular font size. However, if the number of characters in the message exceeds the number that can be displayed with given limitations of screen size, the message overflows the screen and the user has to activate a scroll mechanism to read the entirety of the text.

Rather than employing fixed systems of information presentation, it is of interest to have the information presented in a manner (e.g., font size, color, placement, etc., on a visual presentation component) that is in accordance with a previous activity, current activity, future activity, previous location, current location, future location, the identity, and the like, of a user receiving the information. The current activity, future activity, current location, identity, and the like, as described herein, can be considered the context of how a device is being operated, as well as inferences based thereon. Determination of the context of operation of a user device allows for information to be presented on the user device in accordance with the determined context of operation. Hence, continuing with the first example, it would be of benefit to determine that the current operation of context for the user is jogging, and accordingly, display the text at a larger font size so the user can read the text without having to curtail their jogging activity.

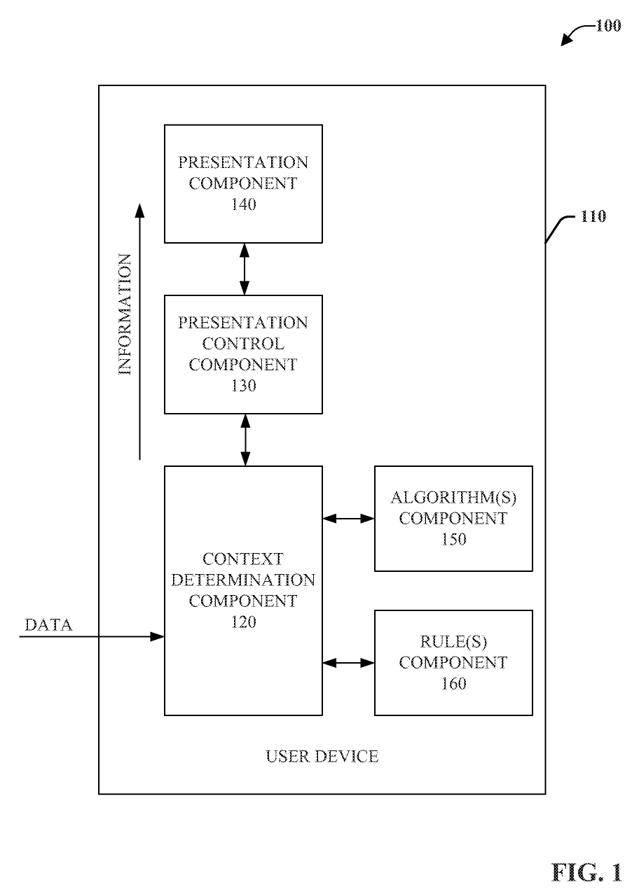

FIG. 1 illustrates a system 100 for contextual presentation of information based on various aspects and embodiments as disclosed infra. System 100 includes a user device 110 comprising a context determination component 120, which in conjunction with a presentation control component 130 can control how information is to be presented on a presentation component 140. Operation of the context determination component 120 can be supplemented by algorithms (algorithm(s) component 150) and rules (rule(s) component 160). Data is received at context determination component 120, and based upon the context of operation of user device 110, information is accordingly presented on presentation component 140.

As mentioned, by determining the context of a user and their situation, it is possible to adjust how information is to be presented to the user. Expanding upon the previous example further, where a person is jogging on a trail when they receive a message on their cellphone, e.g., the message is an SMS message. Under traditional, non-context sensitive situations, the text will be presented in accordance with a standard font size for displaying SMS text on the presentation component 140, e.g., 10 pt font size. However, while the standard font size may be suitable for viewing the SMS message when the user is stationary (e.g., sat down), or walking, the standard font size may not be of sufficient size to allow the user to read the text without them having to curtail their current activity, e.g., have to stop jogging. By employing a context determination component 120, the activity, location, and the like, of a user, can be determined and based thereon, the font size employed to render the information on the presentation component 140 can be adjusted to allow the user to view the information without having to curtail their current activity, whether momentarily or permanently.

Further, if the user performs a certain activity at a particular location the context determination component 120 can infer that, based on prior history of activity, when the user is at that location in the future, there is a likelihood that a particular activity is going to be performed, e.g., jogging along a trail.

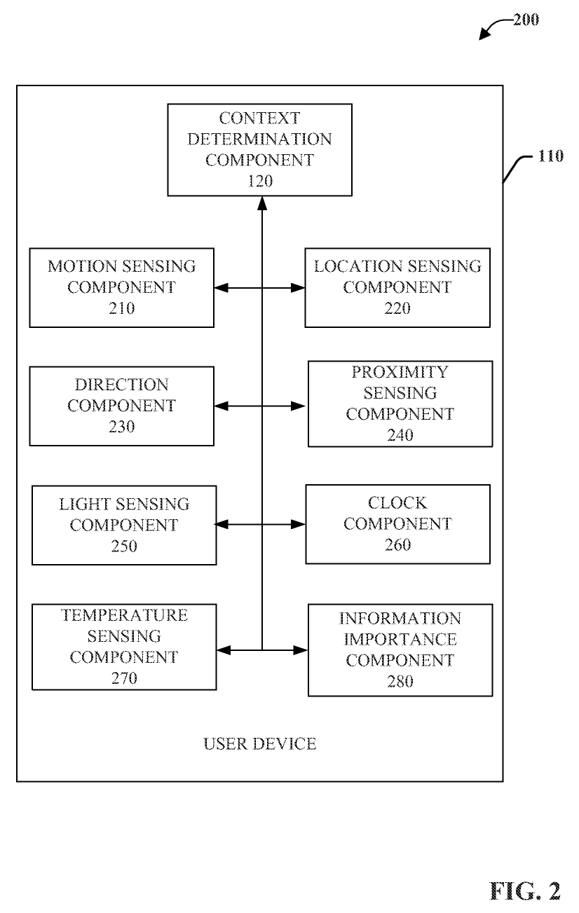

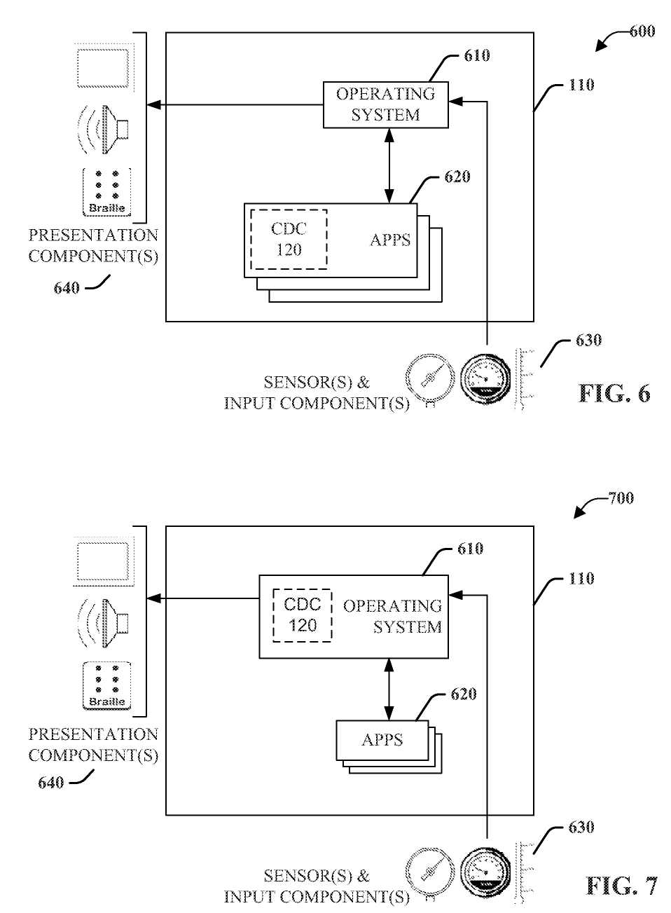

In another example, even though a user is at a location at which they normally perform a particular activity such as jogging, the context determination component 120 can obtain data from various monitoring components (e.g., ref. FIG. 2, sensors and input devices 210-280, FIGS. 6-9, sensor(s) and input component(s) 630) to confirm that the activity of jogging is being performed. For example, while the user normally jogs along a particular trail, in this instance they have decided to walk along the trail. By monitoring received location and/or motion data, the context determination component 120 determines that the user is moving at a velocity slower than jogging, and, accordingly, the font size can be reduced from 16 pt to 12 pt.

A presentation component 140 can be any suitable device to facilitate presentation of information. The presentation component 140 can encompass a variety of presentation apparatus of any size ranging from a GUI found on small mobile devices such as a cellphone, smart phone, MP3 players, personal digital assistant (PDA), palmtop computer, and the like, through to larger devices such as laptops, e-book readers, dashboard mounted devices in automobiles etc., through to GUI's on computers, larger wall mounted monitors, projection systems, and the like. Further, in an embodiment where the presentation component 140 presents information visually, the presentation component 140 can comprise any particular technology that facilitates visual conveyance of information such as a cathode ray tube (CRT), liquid crystal display (LCD), thin film transistor LCD (TFT-LCD), plasma, penetron, vacuum fluorescent (VF), electroluminescent (ELD), laser, and the like. Further, presentation component 140 can comprise a projection component such as a head up display, projector, hologram, and the like. Furthermore, presentation component 140 can comprise part of a haptic display system.

While much of the description relates to the presentation component 140 being a display device, and primarily concerned with visual presentation of information, other types of presentation components 140 can be implemented with the various aspects included herein. The presentation component 140 relates to presenting information and detection of such presentation based on any of the human senses such as sight, hearing, touch, small, and taste. For example presentation component 140 can be an audio output device (e.g., a speaker) that presents information to user using audible means. Further, an example of touch related is presentation component 140 being a device facilitating presentation of Braille to a user, where dots comprising the two three-dot (or four-dot) columns are raised/lowered to form Braille characters for reading by touch. Further, presentation component 140 can involve a sense of smell, whereby compounds, molecules, and the like, having odorous characteristics can be emitted by a suitable device. For example, in the field of gas technologies odorants, such as t-butyl mercaptan and thiophane, are added to natural gas to assist in the detection of gas leaks. Further, the presentation component 140 can be employed to generate molecules, compounds, etc., associated with the sense of taste. Other presentation methods can relate to such aspects as nociception, equilibrioception, proprioception, kinaesthesia, time, thermoception, magnetoception, chemoreception, photoreception, mechnanoreception, electroreception, detection of polarized light, and the like. Further, it is to be appreciated that while the various aspects described herein relate to the human environment, the subject innovations are not so limited and can be extended to encompass animals, electronic systems, and the like.

How information is rendered on the presentation component 140 is controlled in part by presentation control component 130. Presentation control component 130 can control such specifics as text font size, text color, placement of information, time period of information display, etc. In one aspect, such control can, in part, be based upon standards, protocols, and specifications such as hypertext markup language (HTML), extensible markup language (XML), and the like. A typical markup language will intermix the text of a document with markup instructions (tags) that indicate font (<font></font.), underline (<u></u>), position (<center>, <top>, <bottom>, <left>, <right>, etc.), color (<bgcolor>), and the like. Values associated with the markup instructions can be changed thereby changing how information is presented on a presentation component 140, e.g., on a visual display font size can be increased from 10 pt to 20 pt. In one aspect, the presentation control component 130 can control the presentation component 140 by means of a device driver located at the presentation control component 130. Alternatively, in another aspect, a device driver can be located at presentation component 140 which can be under the control of presentation control component 130. In another aspect, the presentation control component 130 can be a device driver.

Further, in another aspect, the context determination component 120 can operate in conjunction with applications (as described infra) running on the user device 110. The applications can forward sensor or input data to a context determination component 120 for analysis by the context determination component 120. In another aspect, the context determination component 120 can employ one or more applications to convey context control information to a device driver controlling operation of a presentation component 140.

In a further alternative aspect, the context determination component 120 can operate in conjunction with an operating system (OS) (as described infra) of a particular user device 110. The OS can forward sensor/input data to a context determination component 120, and/or receive presentation control information from a context determination component 120 to facilitate presentation of information on presentation component 140. The context determination component 120 can provide assistance and extension of how an OS renders information on a presentation component 140. For example, a context determination component 120 can analyze received sensor data and based upon the analysis, and according context of usage of user device 110, the context determination component 120 can select a particular means (e.g., a particular stylesheet) for presenting the information on presentation component 140 and forward the particular means (e.g., the stylesheet) to the OS for employment by a browser controlled by the OS.

The context determination component 120 can receive data from a variety of sources (ref. systems 200-1000) and the data can be employed to facilitate determination of the context of operation of user device 110. In one aspect, the context determination component 120 can employ one or more algorithms to facilitate determination of a “context score” which in conjunction with referring to values in a lookup table, enables the context determination component 120 to direct the presentation control component 130 regarding how information is to be presented on presentation component 140, as discussed infra. The algorithms can be sourced from an algorithm(s) component 150. The algorithm(s) component 150 can contain one or more algorithms which can be called upon by the context determination component 120 in accordance with a performed context determination. For example, an algorithm can provide simple correlation between data obtained from a single source such as a velocity (e.g., received from motion sensing component 210) and an according determination of font size to be employed on presentation component 140 based upon the received velocity. In this example, the algorithm performs a simple function of converting a raw input value into an associated text font size. In another aspect, one or more algorithms can be applied as the number of data input streams increases and, accordingly, the complexity of associated context determinations and number of parameters affecting information presentation increases. Data can be sourced from a plurality of sensors and input components associated with a determination, with a single determination involving monitoring a myriad of variables such as velocity, acceleration, pressure, barometric pressure, time of day, ambient light, location of user device 110, proximity of a user to user device 110. The determination can be combined with such considerations as prior history of operation and inferred future operation of user device 110. Accordingly, there can be a wide range of parameters affecting presentation of information to be determined, e.g., font size, font color, position on presentation device 140, information to be displayed?, notification of information to be conducted by audio signal, visual means, vibration, and the like.

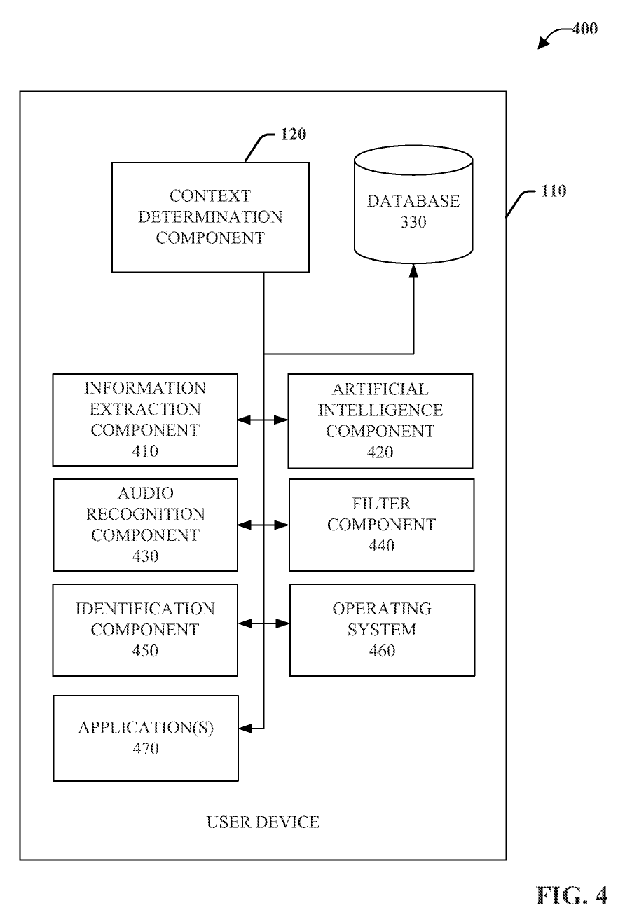

Further, “rules” can be employed by the context determination component 120 to affect and effect presentation of information on presentation component 140. The “rules” can be sourced by the context determination component 120 from a rule(s) component 160. In one aspect, “rules” can be hard, whereby they are not allowed to be adjusted to affect operation of a presentation component 140. In another aspect, pre-configured “rules” (e.g., “rules” pre-stored in a “rules” component by an OEM) can be adjusted by a user. In another aspect, “rules” can be created by a user of user device 110. For example, a “normal rule” can be created to be employed when a user is using user device 110 walking along a street (e.g., the “normal rule” allows notification by audible means). Alternatively, a “theater rule” can be created that is employed when the user device 110 is determined to be located in a theater setting, where the user of user device 110 wants notification to be performed by vibration means. “Rules” can also be affected and adjusted by components comprising user device 110, e.g., artificial intelligence techniques can be applied to a “rule” to improve its effectiveness based upon current context, prior history of operation, inferred future operation, and the like (ref. FIG. 4, artificial intelligence component 420).

User response to presentation of information on a presentation component 140 can take many forms, including no action, respond to the information (e.g., information is SMS message, email, twitter, or the like), override the presentation of the information according to the context and have the information displayed at a default font, and the like. Further, the user can adjust any “rules” and algorithms used by the context determination component 120 to suit their individual requirements.

FIG. 2 illustrates a system 200 facilitating determination of a users location, activity, etc., from which a context of how they may want to interact with a user device 110 can be determined. A context determination component 120 communicates with one or more of a plurality of components enabling the context determination component 120 to determine the context of a users previous/current/future activity, previous/current/future location, etc., and thereby adjust how information is conveyed by the presentation component 140 of user device 110.

The plurality of components include a motion sensing component 210 which provides data relating to the motion of the user device 110. The location of the user device 110 can be determined based upon on data provided by a location sensing component 220. A direction component 230 provides data on the direction of travel and/or the orientation of the user device 110. A proximity sensing component 240 can be utilized to facilitate determination of how close user device 110 is to another object, e.g., a user of the user device 110. Further, a light sensing component 250 enables determination of the environment in which the user device 110 is operating. A clock component 260 enables the context determination component 120 to determine whether information is to be displayed on presentation component 140 based on date, time, calendar entry, etc. A temperature sensing component 270 can provide data about the environment in which the user device 110 is being operated. An information importance component 280 can be employed to assess the importance of the received information and present the received information in a manner conveying the importance of the information

It is to be appreciated that a variety of components can be employed to provide data to the context determination component 120 to facilitate control of how information is rendered on the presentation component 140 along with operation of user device 110. While FIG. 2 presents examples of such components, 210-280, it is to be appreciated that the variety of components can extend beyond the example components and include other components that provide data from which a context can be established and is not limited to components 210-280. Further, to facilitate discussion, only eight components 210-280 are presented in FIG. 2, but it is to be appreciated that component 210-280 and other components presented in systems 100-900 can be communicatively coupled either directly or via intermediary components (e.g., context determination component 120) to effect operation of the various innovative features described herein. It is to be further appreciated that while the various components 210-280 are shown as separate entities, the context determination component 120 can employ data from an individual component in the plurality of components 210-280, or data from a combination of components 210-280 can be employed to determine how information is to be presented on the presentation component 140.

A motion sensing component 210 can be employed to facilitate determination of whether the user device 110 is stationary or not. In one aspect the motion sensor 210 can comprise an accelerometer that detects magnitude and direction of acceleration from which orientation, vibration, and shock can be ascertained. Any accelerometer can be employed such as a gyroscope, micro electro-mechanical system (MEMS), piezoresistor, quantum tunneling, two-axis, three-axis, six-axis, strain, electromechanical servo, servo force balance, laser, optical, surface acoustic wave, and the like.

The context determination component 120 receives data from the motion sensing component 210 regarding the motion of the user device 110. It is to be appreciated that while the motion determination relates to the user device 110 containing a motion sensing component 210, the motion determination can be extended to infer an activity of a user of the user device 110. For example, the user may be sitting stationary in a café with user device 110 in the user's pocket. The context determination component 120 receives data from the motion sensing component 210 which indicates that the user device 110 is often stationary or undergoes minimal accelerative motion. In assessing the data the context determination component 120 makes a determination that the user is stationary, e.g, sat in a chair, and the minor accelerative motions are, for example, a result of the user adjusting their posture, etc. Based upon such determination the context determination component 120 can effect the presentation control component 130 to employ a font suitable for reading in a stationary mode.

Location sensing component 220 can provide data to the context determination component 120 regarding the location of user device 110. In an aspect the location sensing component 220 can be a global positioning system (GPS). Further, the location sensing component 220 can operate in conjunction with various applications that provide knowledge of a location. Such applications include various satellite navigation systems, geodata based applications, mapping service applications such as GOOGLE MAPS, OPENSTREETMAP (OSM), MAPQUEST, MAP24, and the like. Such applications and systems can extend the knowledge of the location beyond that of simply knowing a latitude and longitude, to knowing a street address, business address, business activity, panorama, landscape contour, elevation, etc.

In an aspect, the presentation of information on the presentation component 140 can be adjusted in accordance with the location at which user device 110 is being used. From information provided by the location sensing component 220, the context determination component 120 determines that the user device 110 is being operated in a particular location, and applications (ref. FIG. 4, 470) and the way in which the applications are being run on the user device 110, can be adjusted in accordance with the determined location. At location A the user prefers that applications x, y, and z, are available for operation on the user device 110, while at location B, applications m, n, o, p, and z, are available for operation on the user device 110.

Before describing other components, it is to be appreciated that data from a plurality of sources can be combined and a determination of context and/or operation can be made based thereon. For example, where a user is working out on a treadmill and has user device 110 on their person, a context determination component 120 can combine data from a motion sensing component 210 and a location sensing component 220 to determine how to present information on the presentation component 140 of user device 110. Owing to the running motion of the user, the motion sensing component 210 provides data that the user device 110 is undergoing acceleration, vibration and shock. Analyzing the received data signal patterns from the motion sensing component 210, the context determination component 120 determines that the user device 110 is undergoing motion and shock corresponding to when the user is running. From the determined running motion combined with a constant location being provided from the location sensing component 220, the context determination component 120 determines that the user of the user device 110 is running in a fixed location, which in all likelihood indicates that the user is running on a treadmill. Continuing the example, while the context determination component 120 has inferred that the user is running on a treadmill, this inference can be supplemented by knowledge received from a mapping service application associated with the location sensing component 220, e.g., the current location is a fitness center.

A direction component 230 can provide data regarding the direction in which the user device 110 is orientated and, based thereon, further information can be presented by presentation component 140. By employing a location sensing component 220 in combination with direction component 230, a user's frame of reference can be determined and according information presented on the user device 110. For example, a user could be hiking in the mountains and wants to identify a particular mountain. Location sensing component 220 can provide data regarding the location of the device, from which a panoramic view can be generated by an application (e.g., an application 470) associated with the location sensing component 220 and displayed on presentation component 140. By orientating the user device 110 with the mountain of interest, a compass bearing obtained from a direction component 230 enables a particular mountain to be identified in the panoramic view displayed on presentation component 140, along with any pertinent information, e.g., distance from current location, elevation, elevation to be traversed, “is there a camping but near the particular mountain?”, etc.

A proximity sensing component 240 can be used to facilitate determination of how close a user is to the user device 110. Suitable techniques include facial recognition techniques, eyewidth determination, transmitter/receiver technologies (e.g., infrared, radar, echolocation, laser), and the like. For example, from a determination of eyewidth distance of a persons face, the distance of how far away is the user from the device can be determined. In one aspect, as the position of the user is determined to be closer or further away, the font with which information is displayed on the presentation component 140 can be enlarged or reduced in accordance with the determined distance. A typical “comfortable” reading distance when reading a user device 110, such as a cellphone, is approximately 10-14 inches from the users face, and a font size of 12 pt may be of a suitable size to render information on the presentation component 140 when viewed at the “comfortable” reading distance. As the user moves away from the user device, as determined by the proximity sensor 240, a distance measure can be provided to the context determination component 120, from which the context determination component 120 signals to the presentation control component 130 indicating that the font size should be increased to allow the user to view the information over the greater distance. For example, the user is located across the room but is interested in information displayed on presentation component 140. With a non-context determination system the information is displayed with a constant font size, e.g., 12 pt., thereby rendering the information unreadable at a distance of approx. 3 feet from the user device 110 comprising a computer monitor, for example. By employing the proximity sensing component 240 the context determination component 120 can instruct the presentation control component 130 to render information with a font size of 20 pt when the user is determined to be 5 feet away from user device 110, and a font size of 36 pt when the user is determined to be 10 feet away. It is to be appreciated that the example values presented throughout the description are simply to aid description of the various aspects and embodiments of the innovation and any value (e.g., distance-font size) pairings can be employed.

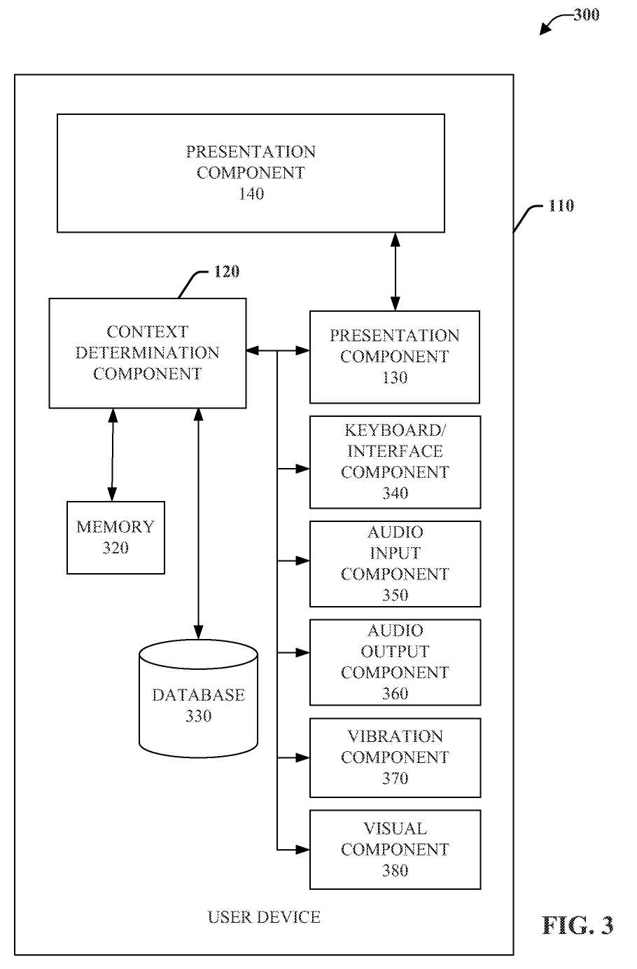

In another aspect, a user can identify a region on the presentation component 140 that they wish to see in preference to other regions of the display, as they move about a room, for example. Typically, websites and the like are displayed on a presentation component 140 using web programming code such as HTML. The user can identify a particular focus point about which they want information such as a webpage, digital document, drawing, etc. to center, as the information on a screen is adjusted as the user moves in relation to presentation component 140 and/or user device 110. In the case of presentation component 140 being a touchscreen the user can touch on a point on the screen for which they want any adjustment in screen size to be centered about. Alternatively, the user can mark out a region of interest by tracing the desired region on the touchscreen. In another aspect, the focal point or desired region can be selected via a keyboard/interface component (ref. FIG. 3, component 340), where such can component is a mouse, joystick, digital pad, and the like.

A light sensing component 250 can provide further information regarding operating conditions of the user device 110. In one aspect, a light sensing component 250 can measure a degree of ambient light in which a user device 110 is being operated. In response to diminishing available light, a context determination component 120 can instruct the presentation control component 130 to display information on the presentation component 140 with a larger font size thereby improving a users ability to read text in low light conditions. Accordingly, as the amount of available light increases the display font size can be reduced. The variation in font size can be in accordance with a user's preference. For example, one person may require a different font size for a given set of light conditions, compared with the requirements of another user.

In one aspect, rather than having the presentation component 140 display the information using a fixed backlight (not shown), the backlight can be adjusted based upon the lighting conditions. For example, during operation in a light environment, e.g., daylight, lit room, etc., no backlight need be used by the presentation component 140. However, during operation in reduced light conditions, e.g., nighttime outdoors, darker room, the backlight can be employed. Further, by knowing the location as well as time, lighting conditions, etc., backlighting can be controlled in accordance with the location, etc. In a darkened environment, e.g., a dark room, information may be displayed on the presentation component 140 with the presentation component 140 using backlighting. However, the darkened environment may be a public location such as a theater, and by knowing such a location, a lower level of backlight illumination can be employed, thereby allowing a user to view information on presentation component 140 of user device 116, while minimizing the negative affects of their actions on those around them.

In an aspect, light sensing component 250 can be a camera located on the user device, e.g., a camera typically found on a cellphone, a webcam connected to a computer, and the like. Various technologies can be employed to analyze data received from the camera and context determinations made therefrom. For example, a camera can be employed to assist in the determination of how a user device 110 is currently being employed (e.g., cellphone is placed by ear, or the user device is currently in a dark environment such as a dark room, pocket, etc.).

A clock component 260 can be employed to assist context determination based upon time of day, day of the week, etc. Further, the clock component 260 can operate in conjunction with a calendar application (not shown), where, in one aspect, calendar entries can be employed to generate information for display on the display device 140, e.g., a meeting notification.

A temperature sensing component 270 can be utilized to provide information regarding the environment in which the user device 110 is being used. For example, if a temperature reading of approx 98F is measured by the temperature sensing component 270, this reading can be used by the context determination component 120 in ascertaining that the user device 110 is being carried by the user on their person, e.g., in their pocket.

In another aspect received information can be flagged based upon degree of importance to the user, degree of importance to the sender (e.g., normal, high, urgent levels of importance), information source, and the like. Accordingly, an information importance component 280 can be employed to assess the importance of the received information and present the received information in a manner conveying the importance of the information. Such manners of conveying the importance can include employing a distinctive color for each importance level (e.g., red font=urgent), a specific audio tone can be employed (ref. FIG. 3, audio output component 360), a specific sequence of vibrations (ref. FIG. 3, vibration component 370), a specific visual notification (ref. FIG. 3, visual component 380), notification can be repeated with a specific repetition (e.g., every 2 minutes) until the user of the device acknowledges they have received the information, and the like. The information importance component 280 can also review the source of the information and effect according display of the information on presentation component 140 (e.g., when a doctor receives a message from an intensive care unit (ICU) the message is to be displayed in red). In one aspect “rules” of notification can be employed by the information importance component 280, where the “rules” can be configured in accordance with a network in which the user device 110 operates, e.g., in a hospital network information received from an ICU is displayed in red, if the information is received from a hospital ward it is displayed in blue. In an alternative aspect, the user of user device 110 can create their own “rules” for how information is to be presented on presentation component 140, and/or how notifications are to be conducted. For example, information received from an ICU is to be notified by repetitive flashing of visual component 380 until the user indicates receipt of the information (e.g., via keyboard/interface component 340—ref. FIG. 3). As discussed previously, notification “rules” can be stored in the “rules” component 160.

Data can be obtained by the context determination component 120 from the various components 210-280 in a variety of ways. The various components 210-280 can be continually polled and data retrieved therefrom, where the polling can be sequential or random. In another aspect the components 210-280 can forward data to the context determination component 120 according to a schedule. In a further aspect, the context determination component 120 can request information from a component 210-280 that, ordinarily, is not part of a standard determination process. For example, in one embodiment the context determination component 120 employs data from location sensing device 220. The user enters a building complex that is a multi-use complex (e.g., shopping mall with gymnasium and movie theater). Owing to the user being in an indoor location it is not possible to obtain a reading from the location device, however, a motion sensing component 210 indicates that the user device is undergoing accelerative motion and coupled with the broader knowledge that the complex contains a gymnasium, the context determination component 120 infers that the user is running on a treadmill.

To further understanding of the various aspects presented herein various ways in which a context can be determined will now be presented. In one aspect, context determination can be accomplished in part by employing suitable algorithms to facilitate determination of a “context score”. A “context score” can be generated by the context determination component 120, as a means for evaluating the data received from the various components (e.g., components 210-280) and effecting control of how information is presented on presentation component 140. An example of a “context score” algorithm suitable to be employed by the context determination component 120 is shown below. For the purpose of the description only data for 4 components is shown, however, it is to be appreciated that data from any number and combination of components can be employed in the algorithm.

M+L+D+LS=context score

where M=data reading from a motion sensing component 210, L=data reading from a location sensing component 220, D=data reading from the direction component 230, and LS=data reading from the light sensing component 240. In this example a score is derived by simple summation of the respective values.

In another aspect, a “context score” algorithm to be employed by the context determination component 120 can employ weightings averaging, where data from a particular component(s) can be deemed to be of more importance than data obtained from other component(s).

nM+mL+(D+LS)=context score

In the above example data received from the motion sensing component 210 (M) and the location sensing component 220 (L) undergo weighting, while no weighting is applied to data obtained from the direction component 230 (D), and the light sensing component 240 (LS). It is to be appreciated that in the above example, that the weighting values n and m can be of equal or different values, and include integers, fractions, complex numbers, and the like.

Further, it is to be appreciated that while the example equation can employ scalar weightings n and m, it is envisioned that any method of weighting can be employed, including mathematical techniques such as weighted mean, arithmetic mean, geometric mean, harmonic mean, convex combination, variance, dispersion, least squares, and the like.

In another aspect, the determined “context score” can be compared with a lookup table containing settings controlling how information is presented on presentation component 140, where such control settings (presentation parameters) can include font size, color, placement on screen, display, do not display, do not run application, run limited application, and the like. An example look up table, TABLE 1, is shown below. TABLE 1 correlates user Activity with presentation parameter Font Size based upon a “context score”.

TABLE 1
An example lookup table.

| Activity | Font Size | Context Score |
|---|---|---|
| At rest | 8pt | <6 |
| Walking | 12pt | 6-12 |
| Running | 16pt | >12 |

It is to be appreciated that a lookup table can include any combination of parameters. While TABLE 1 presents correlations of Activity, Font size and a related context score, the lookup table can include other correlations of context score in combination with parameters affecting operation of user device 110. For example, a lookup table can correlate context score with what applications to run and, accordingly, the level of operation of an application when it is operating.

In one example, a user is determined to be stationary at a coffee shop (e.g., the user is sat in a chair reading), and a “context score” of 4 is determined from a context score algorithm. In conjunction with the example lookup TABLE 1 the font size applied to the information presented on presentation component 140 is 8 pt. The user, upon finishing their coffee, gets up and leaves the coffee shop to catch a bus. Analysis by context determination component 120, of data obtained from the one or more components (e.g., components 210-280) generate(s) a determined context score of 9, determining that the user is walking along the street, and in accordance with lookup TABLE 1, the information presented on presentation component 140 is now displayed with a font size of 12 pt. Upon viewing a bus coming down the street the user runs to the bus stop in time to catch the bus. With feedback from the one or more components 210-280, the context determination component 140 determines that the user is running, a context score of 17 is generated, and accordingly information is to be displayed on presentation component 140 screen with a font size of 16 pt. Upon sitting down in the bus seat the data from the one or more components 210-280 generates a score of 5, from which it is determined by the context determination component 120 that the user is effectively stationary on the bus, and information can once again be displayed on presentation component device 140 with a font size of 8 pt.

In the above example, even though the bus may be moving and data from a location component 220 indicates a change in location, an inference can be made by context determination component 120 that the user is sat on the seat owing to data being read from a motion sensing component 210 indicating that the user device 110, and correspondingly, the user is undergoing rapid motion with minimal actual movement by the user.

Further, it is to be appreciated that any algorithm can be employed to assist in the determination of the context of the user. In the above example, the user transitions from running to the bus stop, possibly standing stationary while waiting for the bus, and then potentially begins to move at a speed greater than they can run. Since the motion sensing component 210 indicates that the transition in velocity states occurred at, or in the vicinity of a bus stop (as indicated by location sensing component 220), an inference can be made that the person has transitioned from movement by foot to being in a vehicle. Over a period of time, such repeated changes in motion in the vicinity of a particular location such as a bus stop can be employed to provide improved inference of user activity, as discussed infra.

Furthermore, it is to be appreciated that the various components from which context can be determined, (e.g., components 210-280) can be employing different units of measure, in one aspect a motion sensing component 210 can be providing data indicating miles/hour, while a light sensing component 250 can be providing data correlating to lumens. Further, in another aspect a single component can be providing a plurality of data types, e.g., motion sensing component 210 can be providing velocity data in metres/second, and acceleration data in metres per second squared (m/s²). Furthermore, in another aspect, to “equalize” the various data streams, equalizing factors can be applied to the data to adjust data ranges to ranges that can reflect the magnitude of the data being measured. For example, a viewing distance of 20 feet (as determined from data provided by proximity sensing component 240) can result in information being displayed on presentation component 140 with a 20 point font, a same font size resulting from a velocity reading of 8 mph when a person is jogging (as determined from motion sensing component 210).

Further, it is also to be appreciated that operation of any of the monitoring components 210-280 can be updated. For example, context determination component 120 can send configuration data to a monitoring component thereby affecting operation of the monitoring component. Where a device driver (not shown) is incorporated in a monitoring component (components 210-280), the device driver can be updated in accordance with information received from the context determination component 120.

It is also to be appreciated that as well as the context determination component 120 employing information received from the components 210-280 to determine information display on the display component 140, a history of user activity can be compiled from which a current and future activity can be inferred

FIG. 3 illustrates system 300 depicting various components which can be employed to facilitate context determination and operation of user device 110. Such components include components involved in the processing of information such as memory 320 and database 330. Other components include various input/output components which can supplement the operation of presentation component 140, such as a keyboard/interface 340, audio input component 350, audio output component 360, vibration component 370, and visual component 380.

Any pertinent data may be stored or retrieved from a storage device such as memory 320 and application associated therewith, e.g., database 330. While they are shown separately, the database 330 can be internal or external to the memory 320. Further, while only one memory 320 and database 330 are shown, a plurality of such memory and database(s) can be distributed as required across systems 100-1000 to facilitate collection, transmission, generation, evaluation, and determination of a variety of data to facilitate operation of the context based process. Furthermore, memory 320 and/or database 330 can be incorporated into the user device 110 or can be stored on a removable memory device such as a flash memory. Also memory 320 and/or database 330 can reside external to the user device 110 with any suitable means being employed to store and/or retrieve data at the external device providing memory or database operations. Data for storage and retrieval to the database can include any data gathered from and/or generated by the various components comprising systems 100-1000, including monitoring data, historical data, inferred activity data, data received from or transmitted to external devices and programs, and the like. Also, it is possible to erase/archive any data or information stored in memory 320 and/or database 330. Furthermore, data can be stored over a period of time thereby allowing subsequent analysis and inference of the data and operation of user device 110 to be performed. In another aspect, the stored data can be analyzed as part of a self learning operation performed by any of the components comprising user device 110, where such self learning can be supplemented by artificial intelligence techniques provided by artificial intelligence component 420 (ref. FIG. 4.).

The keyboard/interface component 340 facilitates interaction by the user with the user device 110, and components comprising the user device 110. The keyboard/interface component 340 can comprise of any suitable layout ranging from a keypad/keyboard with a small number of keys, through to a keypad/keyboard comprising a plurality of keys, e.g., a QWERTY keyboard. Further, the keyboard/interface component 340 is not limited to being a keypad/keyboard but includes any suitable means for interacting with the user device, including a mouse, joystick, projection keyboard, trackball, wheel, paddle, touchscreen, pedal, yoke, throttle quadrant, optical device, head-up-display, instrument panel, and the like. Further, the keyboard/interface component 340 can comprise alphanumeric and symbol keys as well as keys displaying graphics/icons/symbols as employed as part of the operation of the various aspects described herein. Further, the keyboard/interface component 340 can be separate to the presentation component 140, or an integral part of presentation component 140. For example, the presentation component 140 is a touchscreen display and the keys comprising the keyboard/interface component 340 are displayed as part of the presentation component 140.

To facilitate operation of the one or more aspects disclosed herein, the keyboard/interface component 340 can display keys showing various options available to the system. For example, the keys can display symbols indicating the various contexts employed in the one or more aspects presented herein. For example, keys can be displayed on the keyboard/interface component 340, indicating a variety of activities such as sitting, walking, running, driving, sitting on a bus, etc. As the user transitions from one activity to another, the user can select the appropriate symbol key for the current or pending activity thereby assisting the context determination component 120 in its determination of how to present information, as well as building a context history. For example, at the start of going jogging the user can select a button on the keyboard/interface component 340 associated with the activity of jogging. By receiving an indication of activity from the user enables the context determination component 120 to build a history of data from the various monitoring devices (components 210-280) when a particular activity is being performed, e.g., data is obtained for running, walking, sitting, etc.

In an alternative aspect, the user can employ the keyboard/interface component 340 to override the context determination component 120 and to present information in a specific/preferred way, e.g., regardless of current determined context, display text on presentation component 140 using a font size of 12 pt. Further keyboard/interface component 340 can facilitate user interaction with various “rules”, algorithms, etc, presented herein. In one aspect, rather than a user having to adjust an algorithm based upon a specific magnitude of measured value, e.g., a velocity in mph, the algorithm can be adjusted by fine tuning the setting using+/−keys around an arbitrary setting as opposed to a specific value.

User device 110 can further comprise an audio input component 350. The audio input component 350 can comprise of any device suitable for capturing audio signals such as voice, music, background sound, and the like. In one aspect, the audio input component can comprise a microphone which can receive voice commands to be employed to control the presentation of information on the user device 110. For example, a user of user device 110 can say “8 pt” to indicate their desire that any information is displayed with a font size of 8 pt on presentation component 140. If the font size is to be increased or decreased from a current size, the user can instruct the user device 110 (and accordingly, presentation control component 130) what font size to employ.

The audio output component 360 can provide supplementary notification of information being received, available for viewing on the user device. In one embodiment, the context determination component 120 can be configured to perform a specific function when information is received. In one embodiment, the audio output component 360 can be controlled by the context determination component 120 such that when information is received from a particular source (e.g., work) the audio output component 360 operates to produce a particular audio signal.

User device 110 can also comprise a vibration component 370. Operation of the vibration component 370 can be controlled in accordance with context provided by the context determination component 120.

For example, the user of user device 110 may be at the theater and only wishes to be disturbed by information received from a particular source, e.g., a doctor only wants to be notified of information being received concerning a particular patient. In another aspect, the context determination component 120 employs various devices 210-280 to facilitate control of how the audio output component 360 and the vibration component 370 are to be employed to indicate to a user that information has been received at the user device 110. For example, the location sensing component 220 indicates that the user device 110 (and accordingly, the user of user device 110) is currently located in a theater. Out of courtesy to other theatergoers the user defines a series of “rules” to be employed for notification of new data received. Under normal circumstances a “normal rule” can be applied where the user wants to be notified of new information being received by the user device 110, by an audio signal being generated by the audio output component 360. However, when the context determination component 120 determines that the user is in the theater then notification of newly received information at the user device 110 is to be provided by the vibration component 370, and the audio output component 360 is to be switched off/muted in accordance with a “theater rule” which can be provided by the user or as a result of artificial determinations, as discussed infra. At the end of the show, the user carries the user device 110 outside with them. By analyzing data received from, for example, the location sensing component 220 and the audio input component 350, it is determined that the user is walking along the street. Accordingly, owing to the motion of the user, they may not detect vibration of the user device 110, and the context determination terminates activation of the “theater rule”, the “normal rule” is reapplied, and the audio output component 360 is switched back on. Such “rules” controlling how user device 110, and the various components incorporated therein, function can be created using a “rules” application (not shown) with which the user interacts, and the “rules” states can be stored in “rules” component 160. The “rules” can be created based upon any criteria, and can pertain to location, activity, time, etc.

In another example, a new text message is received, and a light sensing component 240 can be employed to provide data to context determination component 120. The light sensing component 240 can detect that it is currently dark, however clock component 260 indicates that it is noon and hence daylight. A reading of 98.6 F is received from the temperature sensing component 270 coupled to a context determination component 120. Based on the above information, the context determination component 120 determines that rather than employing the audible ringtone from the audio output component 360 on user device 110, the vibration component 370 is employed and the user device 110 operates in vibrate mode.

In a further example, it may not be appropriate for the user of user device 110 to be notified of new information available using an audio signal and the user is to be notified by vibration means as provided by the vibration component 370. For example, at the time the information is received and ready to be displayed, the user is at a movie theater and out of consideration to other moviegoers the notification method is switched to vibration. Continuing this example further, the vibration component 370 may have a series of vibration intensities such that, again out of consideration to other moviegoers, a low level vibration is effected by the vibration component 370 so as not to disturb anyone who may still be able to hear the user device 110 vibrating when a standard, more intense level of vibration is employed.

FIG. 4 illustrates system 400 comprising various components which can be employed in a system facilitating and operating with context determination. An information extraction component 410 enables a string of information (e.g., a sentence) to be reduced to a shorter string while still conveying the essence of the concept conveyed in the original string of information. Artificial intelligence component 420 can provide various artificial intelligence and machine learning technologies to be employed by components comprising systems 100-1000. Audio recognition component 430 provides the ability to determine operation of a user device 110 based upon received audio data. Filter component 440 enables selection of information to be presented on user device 110 based upon information source, and the like. Identification component 450 assists in determining what form of operation is to be performed on user device 110. Operating system 460 facilitates interaction of the context determination component 120 (and any associated components) with the operating system layer of user device 110. Applications 470 may be loaded on user device 110 to enable various operations to be performed on user device 110, as well as applications that can be employed to supplement operation of context determination component 470.

An information extraction component 410 can be employed in conjunction with the context determination component 120 to review information for presentation on presentation component 140 and make decisions as to how and what information is to be presented. A user device 110 may include a presentation component 140, e.g., a GUI, which is too small to facilitate rendering of received information in its entirety. For example, the user device 110 may be a cellphone, which owing to issues associated with minimal device size, has a presentation component 140 having a small display area. A traditional method to facilitate display of the received information is for a user to scroll through the text using such means as up/down keys, or interactive regions on a touchscreen. However, the essence of the received information may be discerned from a reduced number of words in the received information. For example, an originally received message may comprise the following “Hi Glenn, hope all is well, the meeting today is at 12.00 PM, at the Villa Beach restaurant on the corner of E6th and Lakeshore Blvd, looking forward to seeing you”. The essence of the message is “Meeting today 12.00 PM, Villa Beach Restaurant”. While the presentation component 140 is not sufficiently large enough size to render the complete message with a 12 pt font size, the information extraction component 410 can review the received information, extract and distill the information down to a number of characters which can be displayed on the presentation component 140. The extracted information may contain sufficient details for the user to fully understand the meaning of the originally received message without having to resort to viewing the original message. In an alternative embodiment, the user can view the original message by pressing a button on keyboard/interface component 340, touching the presentation component 140 where the presentation component 140 comprises a touch sensitive operation, touch a part of the user device where the presentation component 140 operates in conjunction with haptic technology, and the like.

Throughout the description herein, various aspects, embodiments, and examples have been presented where font size has been adjusted in accordance with the operation of user device 110, as determined by the context determination component 120 and thereby controlling presentation of information of presentation component 140 via presentation control component 130. In one aspect, as the size of the font with which the information is displayed changes (e.g., 12 pt to 18 pt), information that could be sufficiently rendered with a smaller font, at the larger font size it may no longer be possible to present the information in its entirety. Accordingly, the information extraction component 410 can be employed to extract the pertinent parts of information from the entire original information, and present the pertinent pieces. As the font size increases or reduces through operation of the user device 110, the information extraction component 410 can be continually reapplied to ensure that important information is presented regardless of font size.

In one aspect of operation, the information extraction component 410 can enable a greater amount of information to be presented on a presentation component 140 as a user approaches the presentation component 140. For example, the presentation component could be a billboard comprising LED technology. Typically billboards have a fixed presentation of displayed information, e.g., an image coupled with a logo, a tagline to capture an individuals attention, and a small amount of text providing ancillary information such as phone number, address, and the like. In accordance with an aspect, the billboard can include a proximity sensing component 240 which detects the respective distance of a person to the billboard. At a certain distance the billboard presents an amount of information as described above. The person may be interested in the subject presented on the billboard, and approaches the billboard. The proximity sensing component 240 detects the person approaching and given the ability of a person to resolve greater detail the closer they are to the billboard (e.g., smaller size font) more information can be presented on the billboard allow a person to increase their awareness, understanding, knowledge of the subject presented on the billboard.

Further, any suitable information extraction technology and techniques can be employed by the information extraction component 410. In one aspect, the resulting extracted information can comprise of a semantically well defined sentence. In another aspect, the extracted information can comprise of words and/or phrases having no semantic structure. Received information can be in the form of a natural language while the information extraction component extracts main terms from the natural language. Information extraction can employs such tasks as content noise removal (e.g., unnecessary information), named entity recognition, detection of coreference and anaphoric links between previously received information and newly received information, terminology extraction, relationship extraction, semantic translation, concept mining, text simplification, and the like. The information extraction operation(s) performed by information extraction component 410 can involve machine learning techniques of an unsupervised and/or supervised nature. The machine learning techniques can be performed in conjunction with the artificial intelligence component 420, described herein.

In an aspect, extracted terms and/or original received information can be placed in memory 320 or stored in database 330. By storing the original message, it is possible for dynamic information extraction to be performed in response to changing operation of user device 110. For example, the user of user device 110 is jogging and information extraction is performed in accordance with context display instructions of font size 20 pt. Rather than read the information while jogging, the user slows to a walk, whereupon the context determination component 120 instructs the presentation control component 130 to display information on the presentation component 140 with a font size of 12 pt. Owing to the size of the presentation component 110 still not being able to display the information in its entirety, the information extraction component 410 can perform another information extraction operation on the original information but this time within the constraints of how much information can be displayed on the presentation component 140 with a font size of 12 pt.

An artificial intelligence component 420 can be employed in conjunction with the context determination component 120, display control component 130, and other components comprising systems 100-1000. The artificial intelligence component 420 can be employed in a variety of ways. In one aspect the artificial intelligence component 420 can assist in the selection of which “context score” algorithm to employ where a plurality of “context score” algorithms are available on a user device 110 to be employed by the context determination component 120. In another aspect, the artificial intelligence component 420 can analyze data being received from the various components comprising user device 110 (e.g., components 210-280) and compare the current input value(s) with historical data (e.g., stored in memory 320 or database 330) and make inferences regarding a future user activity in association with user device 110. In a further aspect, the artificial intelligence component 420 can be employed to select which “rule(s)” to employ in a context determination process. For example, the context determination component 120 determines the user device 110 is being operated in a theater, and the artificial intelligence component 420 infers that a “theater rule” controlling how the user device 110, and components included therein, are to function while the user device 100 is being operated in the theatre.

It is to be appreciated that while the artificial intelligence component 420 is shown as a separate component, any of the various components described herein (e.g., in connection with context determination) can employ various machine learning and reasoning techniques (e.g., artificial intelligence based schemes, rules based schemes, and so forth) for carrying out various aspects thereof. For example, a process for determining a reduction (or increase) in font size can be facilitated through an automatic classifier system and process. The context determination component 120 can employ artificial intelligence (AI) techniques as part of the process of determining a current context of use of user device 110, as well as a future use. The context determination component 120 can use AI to infer such context as proposed activity to be conducted at a location, size of font to use, volume of audio output component, degree of vibration, amount of backlight to use, etc. Further, techniques available to the artificial intelligence component 420 can be employed by any components comprising system 100-1000, e.g., operation of a monitoring component (e.g., components 210-280, 630) can be adjusted where a device driver associated with a monitoring component is configured to function in accordance with requirements of context determination.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to grant access, which stored procedure to execute, etc. The criteria can include, but is not limited to, the amount of data or resources to access through a call, the type of data, the importance of the data, etc.

In accordance with an alternate aspect, an implementation scheme (e.g., rule) can be applied to control and/or regulate insurance premiums, real time monitoring, and associated aspects. It will be appreciated that the rules-based implementation can automatically and/or dynamically gather and process information based upon a predefined criterion.

By way of example, a user can establish a rule that can require a trustworthy flag and/or certificate to allow automatic monitoring of information in certain situations whereas, other resources in accordance with some aspects may not require such security credentials. It is to be appreciated that any preference can be facilitated through pre-defined or pre-programmed in the form of a rule. It is to be appreciated that the rules-based logic described can be employed in addition to or in place of the artificial intelligence based components described.

It is to be appreciated, that the operation of the artificial intelligence component 420, and any results derived therefrom can involve supervised and/or unsupervised machine learning techniques. In one aspect, supervised techniques can involve a user responding and controlling any results presented by artificial intelligence component 420.

In another aspect, the artificial intelligence component 420 can be employed to monitor how far from a standard setting a user sets their preferred setting. Initial operation of the user device 110 with a context determination system 120, will typically involve operation of user device 110 based upon a series of standard settings for a given context. For example, at a given velocity sensed by motion sensing component 210 information is to be presented on presentation component 140 with a font size of x. However, over time a user adjusts the font size for a given velocity from font size x to a font size y. Artificial intelligence component 420 can review the user preference settings versus the standard settings and make inferences based thereon.

User device 110 can include an audio recognition component 430 which can analyze incoming audio signals. In one aspect, the audio recognition component 430 can be connected to audio input component 350 (as presented in FIG. 3), where the audio recognition component 430 can be employed to analyze the incoming audio signal and make determinations and inferences based thereon. In one aspect, the audio recognition component 430 can employ voice recognition technology(ies) to determine the identity of the current user of user device 110. In an alternative aspect, the audio recognition component 430 can analyze audio signals from the background environment in which the user device is being operated and perform operations based thereon. In a further aspect, the audio recognition component 430 determines the volume of the background noise and based thereon, sets an according volume level of operation of audio output component 360. In another aspect the background noise in which the user device 110 is being operated in, e.g., a rock concert, may be too loud to allow for effective notification by audio output component 360 and the vibration component 370 and/or visual component 380 can be activated either singly or in combination.

A Filter Component 440 can be utilized in conjunction with context determination component 120 to facilitate presentation of information on presentation component 140. A filter component 440 can be programmed to control presentation of information on presentation component 140 based upon filtering parameters such as information source, information content, timeliness of information, and the like. For example, in one aspect, the user of user device 110 can instruct the filter component 440 to only allow information received from a particular source, e.g., where the user is a doctor, they can set the filtering parameter to be “only present information received from the intensive care unit”. In another aspect, the user can set the filter component 440 to only allow information received from a particular person, e.g., their wife, to be presented on presentation component 140. Further, in another aspect, any information that is prevented from being presented at a given time can be stored in memory 320/database 330 for viewing at a subsequent time, e.g., when the filtering has been turned off. Operation of the filter component 440 can be in accordance with one or more “rules” that can be stored in memory 320 and/or database 330.

An identification component 450 can be employed on user device 110 and can employ various technologies to facilitate identification of a person, location, etc. In one aspect, identification component 450 can utilize facial recognition techniques to identify a user and thereby adjust operation of user device 110 in accordance with those preferred by, or available to, a particular user. In a situation where user device 110 is used by a plurality of users the way the information is presented may adjust to the preferred settings associated with a particular user, e.g., font size, location of information on the presentation component 140, information to be displayed on presentation component 140, and the like. For example, in a hospital a doctor may be interested in information about a patients vital signs and wants a history of such information to be prominently displayed on presentation component 140. A nurse, however, prefers display of information regarding the patient's medications and schedule, with vital sign information not being of high interest to the nurse. When the person viewing the presentation component 140 is determined to be the doctor then the presentation component 140 will adjust to display the information of interest to the doctor (e.g., vital signs and history), and in the form that the doctor prefers, e.g., font size, font color, blood pressure reading in lower left of the presentation component 140 screen, heart rate top right, etc. When it is determined that the nurse is viewing the presentation component 140 the information is displayed as preferred by the nurse, e.g., the blood pressure and temperature are both displayed in the top left, and the medication history/schedule being prominently displayed, with a particular font size, font color, etc. Information displayed may be of common interest to the viewers or unique to a particular viewer.

In another aspect, where the user device 110 is shared between a plurality of users, the identification component 450 can be employed by the context determination component 120, to facilitate control of how information is presented on presentation component 140, and in a further aspect, what applications are running and/or to be run, on the user device 110. For example, a child is operating user device 110 and parental control settings are applied to the user device 110 to limit and/or control which applications (e.g., applications 470), and information pertaining thereto, are running on the user device 110. Upon determination that an adult is now operating user device 110, the parental controls can be lifted and full operation of the user device 110 along with all the applications operating thereon, can be resumed. With one user, the applications, display of information, etc. can be limited to a specific range/settings, while with operation by another user the applications and functionality of the user device 110 can be performed to their fullest extent.

In another aspect, the identification component 450 can include other components (not shown) that can facilitate identification of a user or user device 110, where such components can solicit information such as a pass code (e.g., Personal Identification Number (PIN)), password, pass phrase, and the like (e.g., entered with keyboard/interface component 340). Other components can be employed with identification component 450 to implement one or more machine-implemented techniques to identify a user based upon their unique physical and behavioral characteristics and attributes. Biometric modalities that can be employed can include, for example, face recognition, iris recognition, fingerprint (or hand print) identification, voice recognition, and the like. Based upon such identification techniques, control of which software and applications are to be made available on user device 110 to a user, how information is presented on presentation component 140, context history of the user, which components and how they are to employed, e.g., provide information notifications, and the like, can be effected on the user device 110.

In a further aspect, once the identity of the user has been determined, preferred settings for the user device 110 can be employed for the determined user, e.g., a preferred font size to display information such as when a user has sight issues such as shortsightedness.

Further, as described herein, (ref. FIGS. 6-10), user device 110 can include an operating system (OS) 460 which controls operation of user device 110, functioning of applications based thereon, etc. The context determination component 120 can interface/interact with OS 460 in a plurality of ways depending upon whether OS 160 is accessible to third party development or not. Examples of various ways in which the context determination component 120 can interact with OS 160 are presented in FIGS. 6-10.

A multitude of applications can be installed on user device 110, with many being suitable for interaction and control with various aspects of context determination as presented in the description. Application(s) 470 can include various office suite applications (e.g., OFFICE, EXCEL, WORD, POWERPOINT, ACCESS, WORDPERFECT, OPENOFFICE, etc.), email client, SMS client, web browser (e.g., FIREFOX, IE, OPERA, CHROME), web design (e.g., DREAMWEAVER, EXPRESSION, FUSION, etc.), social media, game, graphic design packages (PHOTOSHOP, CORELDRAW, ILLUSTRATOR, AUTOCAD, SOLIDWORKS, etc.), calendar, etc. Further, applications 470 can be involved in monitoring information received from sensors and input components (e.g., components 210-280), as well as presenting information to a user (e.g., presentation control component 130, presentation component 140).

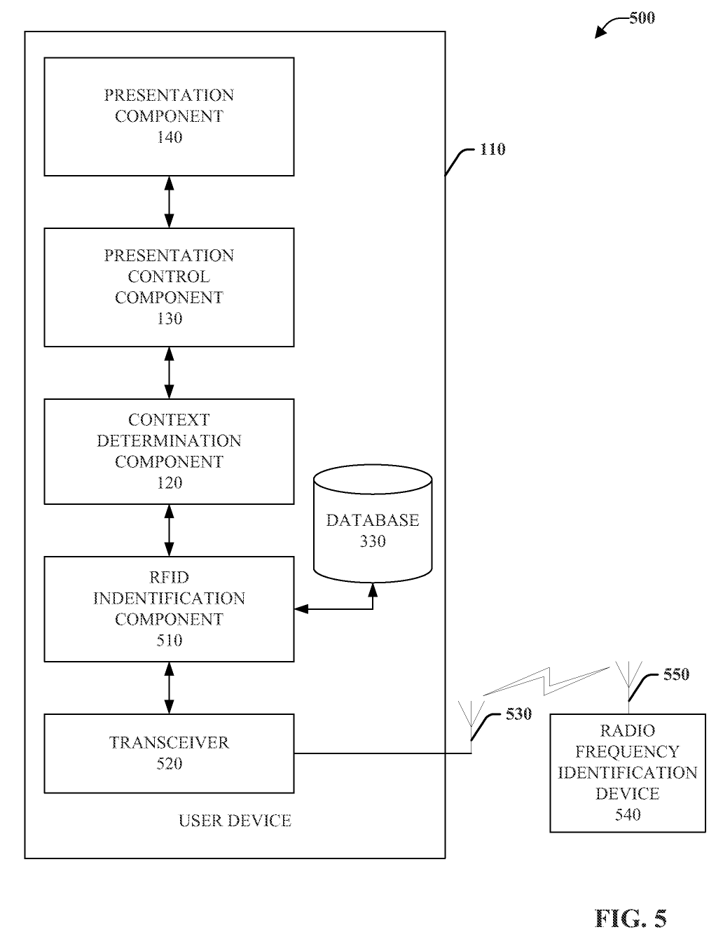

FIG. 5 illustrates system 500 for context based information display with a radio frequency identification device (RFID). System 500 comprises user device 110 in wireless communication with a radio frequency identification device (RFID) 540. RFID 540 technology facilitates identification of a person or object, and when brought within transmission range of the user device 110, information can be obtained from the RFID 540, and the user device 110 can be configured accordingly, e.g., how information is to be presented on presentation component 140.

In one aspect, the user device 110 can be assigned to a particular user. The particular user can be identified by an RFID they have on their person, e.g., a doctor at a hospital wears an identification badge that includes RFID 540. When the person employs the user device 110, the user device 110 and the RFID 540 can be communicatively coupled. In one aspect information can be retrieved from the RFID 540, via antennas 530 and 550 and transceiver 520, and reviewed by the RFID identification component 510. A comparison of the information retrieved from RFID 540 can be compared with user information stored in database 330. If the information is found to match then the user device can be operated by the user. If the information does not match then the user device is not operable by the user. In one aspect, the RFID identification component 510 can function as a security/enablement component for user device 110.

In another aspect, the RFID identification component 510 can receive information from RFID 540, identifying the owner of the RFID 540. The received information can be employed by the RFID identification component 510 to retrieve user information from database 330. The user information can include preferred settings of user device 110 for the owner of the RFID 540. The preference settings can be retrieved from the database 330 (e.g., by the RFID identification component 510 and/or by the context determination component 120) and presentation of information on presentation component 140 is configured accordingly. The user preference settings can also control how various components comprising user device 110 (systems 100-1000) operate, what “rules” to employ, what “context score” algorithms to apply, what applications to enable, and the like. In another aspect, user preference settings can be stored on RFID 540 and retrieved therefrom to facilitate operation of user device 110 in accordance with the settings stored on RFID 540. In a further aspect, user preference settings retrieved from RFID 540 can be stored in database 330 for current and future use. In a future operation where RFID 540 is recoupled to user device 110, user preference settings stored in database 330 can be compared with the current user preference settings stored on RFID 540, and any updates to the user preference settings in database 330 can be performed.

In another aspect, the person may be carrying a device that allows their identity to be known, e.g., they are carrying an RFID from which their relation to the subject matter presented on presentation component 140 can be ascertained. For example, a person in an airport may have an RFID device incorporated into their airplane ticket. A presentation component 240 which typically presents airplane departure/arrival information can be adjusted to present departure/arrival information pertaining to the airplane ticket.

In another aspect, identification can be provided by information from other sources and not limited to RFID technology. For example, a person can be identified by information contained on a cellphone on their person, whereby rather than being identified by an RFID, they are identified by unique information incorporated into a subscriber identity module (SIM) installed on their cellphone.

In an alternative aspect, the user device 110 can “sense” its location, and based on the “sensing” the information presented on presentation component 140 can be adjusted to that which pertains to a particular location, over a different location. Location information can be provided by location sensing component 220. Alternatively, location information can be provided by one or more RFD's 540, which can be located about a complex, e.g., a hospital, and the information presented on presentation component 140 adjusts in response to the location determination. Applications 470 running on user device 110 can be controlled/executed/terminated based on a location determination. For example, application x is to be operable when at location x, while at location y application y is to be operable. Further, a record of which applications 470 were employed at a particular location can be compiled, and when a user revisits a location a particular application 470 can be automatically executed on user device 110.

The user device 110 and the various components it comprises (systems 100-1000) can be updated via hardwire e.g., connecting the user device 110 to a computer etc. to install/upgrade software which can be downloaded from the internet. Alternatively, an upgrade can be transmitted to the user device 110 by wireless means. As a further alternative, while the various components comprising (systems 100-900) the user device 110 are shown as permanently located in the user device 110, any of the one or more components can be available as a separate component that can be added to the user device 110, for example, as a plug-in module, or as an external component communicatively coupled to the user device 110, where such communicative coupling can be facilitated by wireless or hardwired means.

While the discussion supra, has generally focused on the user device 110 being employed by a user in the activities of sitting, walking, running, etc., application of the various embodiments disclosed herein is not so limited. The concepts presented herein can be extended to incorporate any suitable situation. For example, one or more embodiments can apply to operation of a user device in a moving vehicle, such as an automobile. For example, presentation component 140 can be a dashboard mounted navigation device (e.g., GARMIN, TOM TOM, and the like) which includes a proximity sensing component 240. Depending on the location of the navigation device the preferred font size for presentation of information to the driver can be determined in conjunction with data received from the proximity sensing component 240.

In an alternative embodiment, various aspects disclosed herein can be applied to the presentation of information where the operating conditions can alter. Under a certain set of operating conditions particular information is to be presented with associated font size, placement on the screen, etc. Under another set of operating conditions a subset of the original information is to be presented with different font size, placement on the screen, and/or other information is to be presented. For example, the various components of user device 110 can be incorporated into an aircraft cockpit. During stable flying conditions a plethora of information can be displayed on one or more presentation components 140 located in an aircraft cockpit. However, when experiencing non-stable conditions, such as air turbulence, the plethora of information to be displayed on the presentation component(s) 140 can be reduced down to just the critical parameters required to operate the aircraft through the non-stable conditions. Upon cessation of the non-stable conditions the presentation component(s) 140 can return to redisplaying the original plethora of information and current information. As indicated in the above example, presentation of information can be adjusted (e.g., minimized/expanded) in accordance with the operating conditions where in one set of circumstances a user is at liberty to view a plethora of information, while under other circumstances a reduced amount of information is preferred enabling a user to make focused decisions based upon the reduced information. In one aspect, the switching between one amount of information to be presented compared with another amount of information can be in accordance with one or more “rules” controlling presentation of information and volume of information to be displayed.

In the above example of an aircraft, the motion sensing component 210 could be a gyroscope, altimeter, airspeed sensor, airframe motion sensors, and the like, which are employed to facilitate monitoring of the various parameters associated with aircraft motion where such parameters include airspeed, altitude, etc.

Returning to the previous example of a user device 110 employing a context determination system 120 being located in an automobile. In one aspect, when the automobile is being navigated over rough/broken terrain, such navigation can be considered to be operating in a non-stable environment. During such operation presentation of information on a presentation device 140 can be effected in accordance with the degree of automobile vibration resulting from navigating the terrain.

It is to be appreciated that while only one of each component is presented in the description to facilitate understanding of the various aspects and embodiments, it is envisaged that more than one type of component can be employed at any given time. For example, user device 110 can comprise of a plurality of presentation components 140, where the plurality of presentation components 140 can be controlled by a single presentation control component 130, or a plurality of presentation control components 130. A plurality of user devices 110 can be communicatively coupled thereby allowing transfer of data therebetween, shared resources such as databases 330, shared components, and the like.

FIGS. 6-9 present example high-level overviews of various implementations of various aspects and embodiments as described herein. A user device 110 comprises an operating system (OS) 610, one or more applications 620 associated with the OS system 610, one or more sensors and input components 630 (e.g., components 210-280), along with one or more output components, are communicatively coupled at the user device. Data is received from the one or more sensors and input components 630, and information, based upon the received data, is presented on one or more presentation components 640 (e.g., presentation component 140).

FIG. 6, illustrates system 600 facilitating context determination and according information presentation based thereon. With FIG. 6, operating system 610 is a self contained system whereby sensors and input components 630 are read directly by the OS 610, and control information from the OS 610 is sent directly to the one or more presentation components 640. To facilitate interaction of a context determination component 120 with the various functions being performed at the OS, in FIG. 6, the context determination component 120 is included in one or more applications 620, by static (compile-time) reference, dynamic (run-time) reference, or direct inclusion of source code, where the applications 620 are interacting with the OS 610. When data is received from the one or more sensors and input components 630 the context determination device 120 receives the data via one or more applications 620 communicating with the OS 610. In response to the received data, the context determination component 120 can control how the one or more presentation components connected to the OS 610 operate. Operation of the one or more presentation components 640 can be controlled by a control component (e.g., presentation control component 130) located at, or, communicatively coupled with the OS 610. An example of such system is an APPLE IPHONE where ability to modify the OS 610, is limited, if at all available.

Turning to FIG. 7, illustrated is a system 700 where OS 610 is open and direct modification can be conducted. With system 700 the context determination component 120 can be incorporated into, or be communicatively coupled to, the OS 610. In one aspect the OS 610 can contain device drivers for interacting with the one or more sensor and input components 630, as well as controlling the presentation components 640. While applications 620 are in communication with the OS 610 they may not be necessary for determination of operation context of user device 110. In system 700 the context determination component 120 can communicate directly with the OS 610 allowing analysis of data received at the OS 610 to be performed by the context determination component 120 and directly controlling how information is presented by the presentation component(s) 640. An example of such system is an open source system such as the Unix/Linux-based operating system.

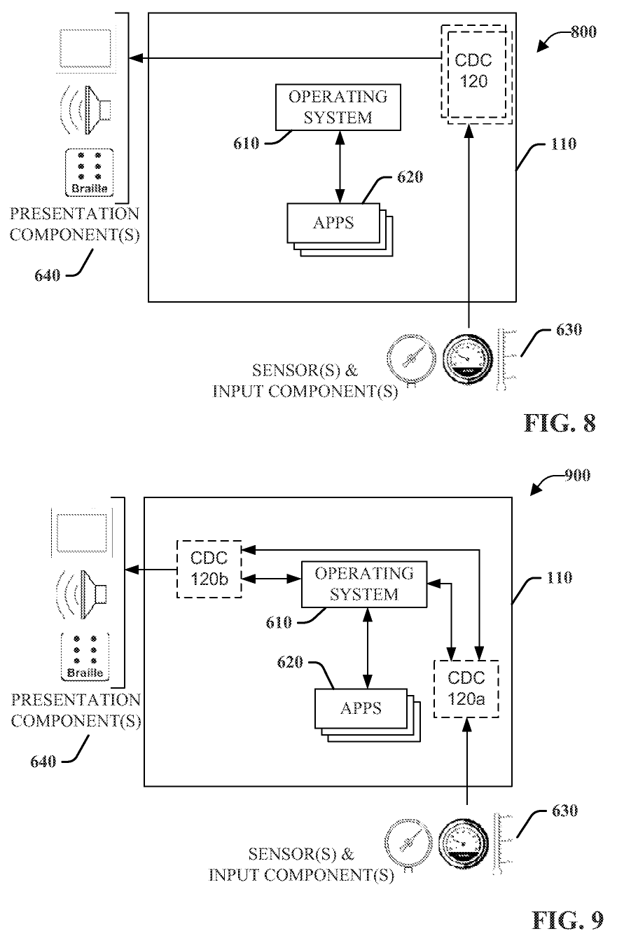

FIG. 8, presents system 800 where context determination can be performed external to an operating system 610. With system 800 the context determination component 120 operates separate to the OS 610 and any applications 620, in effect the OS 610 is oblivious to various aspects of context determination being performed on user device 110. Any sensors and input components 630 are directly coupled to the context determination component 120, where the context determination component 120 can include any device drivers (not shown) required for operation of the sensors and input components 630. Further, the context determination component 120 can include any device drivers (not shown) for operation of the presentation components 640. Sensor/input (e.g., component(s) 630) data is received at the context determination component 120, analysis of context is determined, and the one or more presentation components 640 are controlled (e.g., formatted, etc.) without recourse to the OS 610. Such an application of system 800 is where the OS 610 is a fixed system that, for one reason or another, is not expanded to include context determination. As discussed supra, any data received at the context determination component 120, sensor data, presentation information and data, etc., can be stored on a memory (not shown) coupled to the context determination component 120. In one embodiment of system 800, ambient noise can be received at an audio input component (e.g., from audio input component 350), the context determination component 120 can analyze the received signal, and perform such techniques as frequency determination, equalization, and the like, on the ambient noise. The ambient noise could be received from a factory environment where the factory includes machinery generating noise with a specific periodicity, frequency, and the like. By applying signal enhancement (e.g., noise cancelling) technologies available to a context determination component 120, the received signal can be stripped of unwanted noise, and a cleaned up signal is transmitted via an presentation component (640), such as an audio output component 360. Such receiving, analysis, transformation, and presentation can be performed without interaction by the OS 610.

FIG. 9 illustrates system 900 where context determination components 120a & 120b are acting as supplemental components to OS 610. With system 900 sensor data (e.g., from component(s) 630) is received at OS 610 and outputs generated for presentation components 640. Device drivers, and the like, required for operation of a sensor or input component 630 and, similarly, presentation component 640 can reside either at the OS 610 or at the respective input/presentation component (e.g., components 630 and 640). The OS 610 can be in communication with applications 620, with the operation being enhanced by the context determination component 120. OS 610 has functionality allowing external components (such as the context determination component 120) to have accessibility to the OS 610, the OS 610 includes programming interfaces or “hooks” for such access by a secondary component. For example, an application 620 may be a browser under the control of OS 610. Context determination component 120 may enhance the operation of the browser application by extending how the browser application is to be presented on a display (e.g., presentation component 140). The context determination component 120 can include one or more stylesheets which can be employed by the OS 610. Data, obtained from one or more sensor and input components 630, can be accessed from the OS 610, and analyzed, by the context determination component 120. Based upon the analysis the context determination component 120 can provide the OS 610 with a stylesheet (not shown) for rendering information on a presentation component 640 (e.g., a GUI), where the stylesheet is selected in accordance with the obtained data. For example, data obtained from a light sensor (e.g., light sensing component 250) indicates that the user device 110 is being operated in low light conditions, accordingly the context determination component 120 selects a high contrast stylesheet for presentation of information in a browser operating on an presentation component 640 (e.g., a GUI 140). An example of such an operating system might be MS-Windows or a Unix/Linux-based system that accepts third party drivers.

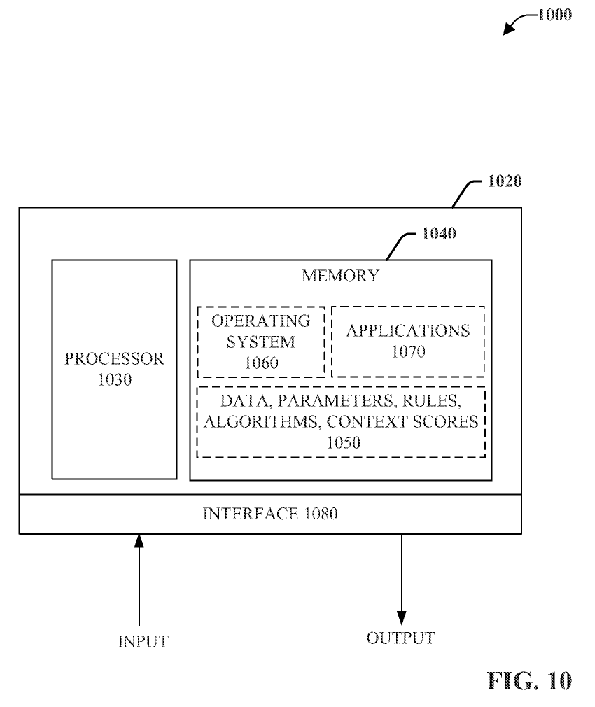

FIG. 10 illustrates a context determination system 1000, employing a system-on-a-chip configuration. System 1000 presents a context determination component 1020 where various components required to facilitate context determination are combined forming a system-on-a-chip. Such an approach enables a context determination system to be employed as a standalone system which can be incorporated into any suitable device. Data inputs can be received at the context determination component 120, and various context determination related processes performed in accordance with the received data. Parameters generated by the context determination system 1020 can be output to provision control of a device communicatively coupled to the context determination system 1020.

The context determination component 1020 can include a processor 1030, which can be employed to assist in performing a number of operations to be conducted by the context determination component 1020, where such operations include, but are not limited to, retrieval of data from various monitoring components (e.g., components 210-280, components 630), determination of context, determination of the criteria/constraints with which data is to be presented, generation, selection and operation of “context score” algorithms, generation, selection and operation of “rules”, storing and retrieval of data, “context score” algorithms, “context scores”, “rules”, and the like.

Further, a memory 1040 is available to provide temporary and/or long term storage of data and information associated with operation of the context determination system 1000. Along with data received from the various monitoring components, “context rules”, context algorithms, “context scores”, presentation parameters (1050), and any required operational data can be stored on memory 1040.

Memory 1040 can further include an operating system 1060 to facilitate operation of the various components comprising system 1000. Applications 1070 can also be available to be utilized by system 1000, where the applications can be employed as part of the context determination process as well performing any ancillary operations.

Further system 1000 can include an interface 1080 which includes necessary functionality to facilitate interaction of the context determination component 1020 with external components such as sensors and inputs (e.g., monitoring components 210-280, components 630, etc.), and output components (presentation component 140, presentation control component 130, output components 640, etc.)

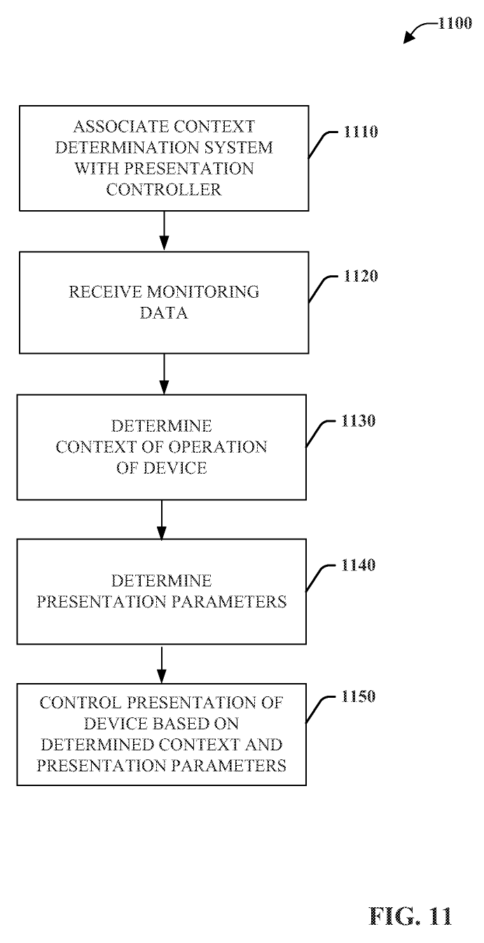

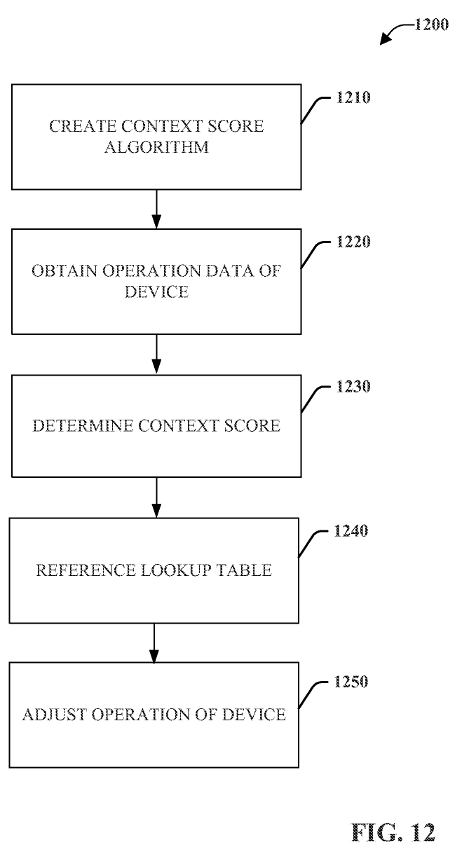

FIG. 11 depicts a methodology 1100 to facilitate presentation of information on a presentation component based upon the context of operation of a user device (e.g., user device 110). At 1110 a context determination system (e.g., context determination component 120, 1020) communicatively coupled with the user device is associated with a presentation controller (e.g., presentation control component 130), where the presentation controller affects and effects how and what information is displayed on the presentation component. The context determination system can be employed by the user device to control how information is presented on a presentation component (e.g., presentation component 140, presentation component(s) 640) associated with the user device (e.g., the presentation component is built into the user device or communicatively coupled thereto) in accordance with how, and, or the environment in which, the user device is being operated.

At 1120 the context determination system receives data from various sources that are monitoring operation of the user device. The sources can include components monitoring operational parameters such as velocity, acceleration, temperature, noise, pressure, user identification, proximity, and the like (e.g., components 210-280 and 630).

At 1130 the context determination system analyzes the received data, and based upon the analysis, a context of operation of the user device is determined. While the various sources at 1020 provide information regarding operation of the user device it is to be appreciated that the operation of the user device can enable inference as to a previous, current, or future activity of a user of the user device.

At 1140 based upon the determined context of operation of the user device, presentation parameters for presenting information on the presentation component are determined. The presentation parameters relate to how information is to be presented on the presentation component and can include such parameters as font size, text color, background color, location on presentation component for displaying information, employ backlight, degree of backlight, and the like. Further, the presentation parameters can relate to how a user is to be notified that new information is available for presentation on a user device, where notification includes vibration, audio, visual means, and the like.

At 1150 information is displayed on the presentation component in accordance with the determined presentation parameters. The presentation parameters are received at the presentation controller and are employed to control how information is presented on the presentation component. For example, where a presentation parameter relates to font size, information associated with that particular presentation parameter is presented on presentation component with the applied font size. In another example, the presentation parameter can relate to notification of new information being by audio means, and accordingly, the user is notified of new information by an audio output device (e.g., audio output component 360).

FIG. 12 depicts a methodology 1200 that can facilitate determination of a context score for operation of a user device (e.g., user device 110).

At 1210 an algorithm facilitating generation of a “context score” is created. A “context score” reflects operation of a user device, and accordingly, facilitates control of various functions and operations of the user device. Such functions and operations can include controlling how information is presented on the user device (e.g., on presentation component 140, presentation component(s) 640), how notifications of available information are to be conducted (e.g., by audio output component 360, vibration component 370, visual component 380, etc.), what applications (e.g., applications 470, 620, 1070)) are to be executed on a user device, and the like.

At 1220 data is obtained from one or more input components (e.g., sensors and input components 630, components 210-280) associated with the user device. The components can be located on the user device or located external to the user device and communicatively coupled to the user device where such communicative coupling can include wired or wireless connection. The one or more components can provide information regarding operation of the user device, location of the user device, operation of the user device in accordance with date/time, and the like.

At 1230, the data is entered into the “context score” algorithm, and a “context score” is generated. In one aspect, the data entered into the “context score” algorithm can be raw values received directly from an input component. In another aspect, the values received can be adjusted so that the effect of data received from one component has a magnitude of impact equal to data having a different range of measurement and/or measurement units, where the first and second data can be received from a common component or two different components. For example, data received from a first component pertains to velocity and has units of miles per hour, while data received from a second component relates to location and is expressed in longitude/latitude. For equal measurement type impact, a change in velocity of 10 miles per hour has an equivalent effect on “context score” as a 1000 m change in longitude/latitude.

At 1240 the “context score” can be compared with value(s) stored in a lookup table (e.g., TABLE 1, supra). Operation settings can then be determined for a particular context score, e.g., if a “context score” of 5 is generated by a “context score” algorithm, then in accordance with corresponding values for a “context score” of 5, information is to be presented on a user device presentation component (e.g., presentation component 140, presentation component(s) 640) with a font of 8 pt. A “context score” of 10 has a corresponding value of font 10 pt in the look up table. A “context score” of 17 has a corresponding value of font 20 pt in the look up table.

At 1250 the operation of the user device is adjusted in accordance with the results derived from the lookup table. For example, where a “context score” of 5 was generated, a font size value of 8 pt was retrieved from the lookup table, and accordingly, information is presented on the user device presentation component at 8 pt.

While not shown in FIG. 12, it is to be appreciated that the algorithm and/or context score can be stored in a memory (e.g., algorithms component 150, memory 320, etc.) coupled to the user device to facilitate storage and access of the algorithm and/or context score as needed during a context determination operation performed by a context determination process employing the context score.

Further, while not shown in FIG. 12, a delay setting can be employed to avoid premature adjustment of operation of the user device, at 1250. Rather than the adjustment of operation being instantaneous in response to every determined change in context of operation, the delay setting can be utilized to provide a more stable response to operational change. For example, a delay setting can be configured such that only if the change in context of operation is still being detected after a certain expired time period (e.g., 15 seconds) is the operation of user device to be adjusted in accordance with the results derived from the lookup table.

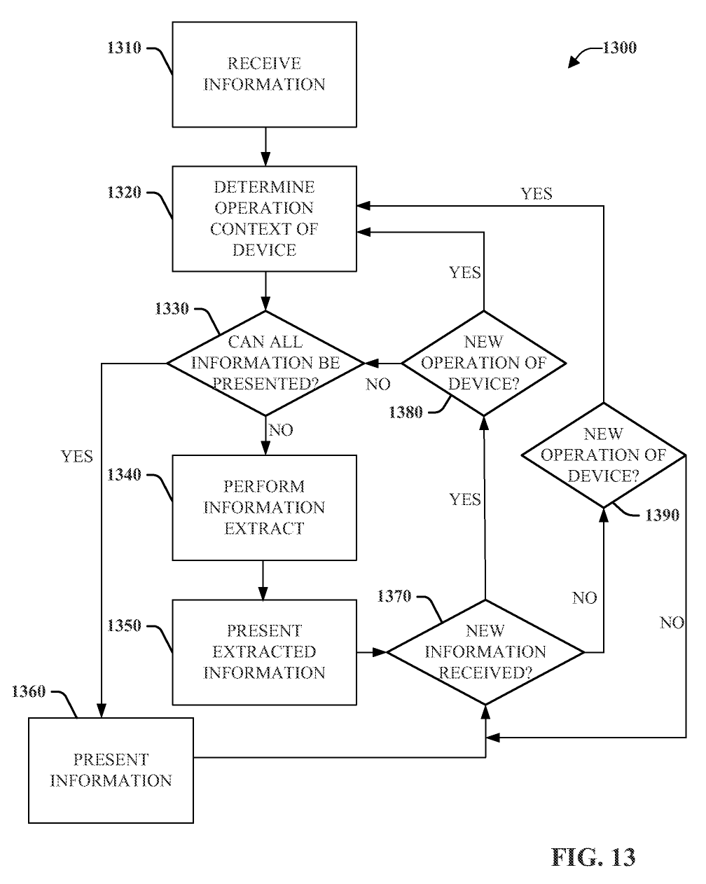

FIG. 13 depicts a methodology 1300 that can facilitate determination of what information is to be displayed based on operation context of a user device (e.g., user device 110).

At 1310 information is received for display on a user device presentation component (e.g., presentation component 140, presentation component(s) 640). The information can be received from an external source, e.g., from the Internet, an SMS message, and the like. The information can also be received from a component comprising the user device 110, e.g., where a user is jogging, a current velocity value can be generated by a motion sensing device located on the user device and displayed to the user of the user device.

At 1320 a context of operation of user device can be determined by a context determination component (e.g., context determination component 120, 1020). In one aspect, a context of operation may mean that information is to be rendered on the presentation component with a particular font size. For example, it has been determined that the user device is undergoing motion and shock associated with when a user of the user device is jogging, and accordingly, information is to be displayed on the presentation component with a font size of 16 pt.

At 1330 a determination is made regarding whether all of the information received at 810 can be presented on the presentation component given the current context of operation. For example, the current context of operation is the user is jogging and information is to be presented on the presentation component with a font size of 16 pt.

At 1340, given that the user is jogging and information is to be presented on the presentation component with a font size of 16 pt, it is not possible to display the received information in its entirety. Accordingly, an information extraction can be performed on the received text to extract a pertinent amount of text that can be presented on the presentation component under the current context settings, e.g., font size=16 pt. Various information extract operations can be performed involving techniques as terminology extraction, coreference and anaphoric linking, and the like, as presented with regard to information extraction component 410.

At 1350 the extracted information is presented on presentation component 140.

Returning to 1330, if a determination is made that the information in its entirety can be presented, at 1360, the information in its entirety is presented on the presentation component.

At 1370, a determination is made as to whether new information is to be presented on the presentation component.

At 1380, upon new information being received, a determination is made as to whether user device 110 is being operated in a new context compared to a context of operation prior to new information being received. In the event that the user device 110 is operating in the same manner as prior to the information being received, the method returns to 1330 where a determination is re-performed to ascertain whether the new information can be presented on presentation component 140 in its entirety. Depending upon the outcome of this determination the method proceeds to 1340 or 1360 as described above.

Returning to 1380, where a determination has been made that the user device 110 is being operating in a new context compared to the context prior to the new information becoming available, the method returns to 1320 where the context of operation is determined. Here the method proceeds to 1330 as described above.

Returning to 1370, in the event that no new information has been received, the method proceeds to 1390 where a determination can be made as to whether the user device 110 is operating under new context conditions. In the event that the determination of 1390 is “Yes” user device 110 is operating under new context conditions the method proceeds to 1320, where a new context determination is performed.

Where a determination at 1390 is “No”, the method returns to 1370 for receipt of new information to be determined. The methodology of 1300 continues to iterate through 1320-1390 based upon new information being available for presentation and/or new context of operation of user device 110. It is to be appreciated, that while not shown, methodology 1300 can comprise a further operation in determining whether there is more than enough space available for display.

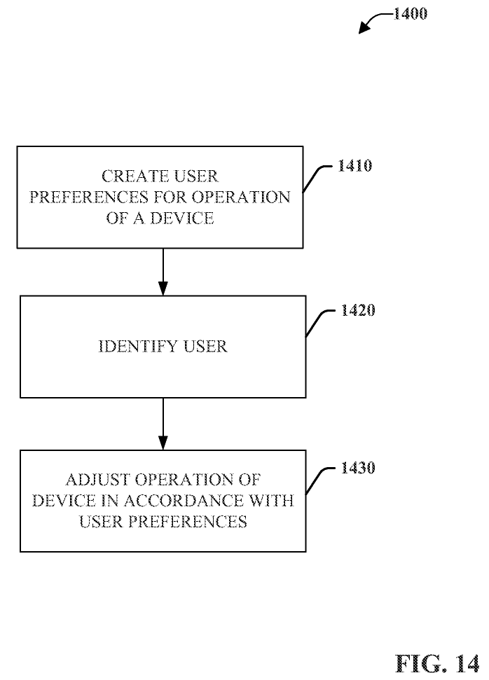

FIG. 14 depicts a methodology 1400 that can facilitate operation of a user device in accordance with user preferences. At 1410 one or more preferences for operation of a user device (e.g., user device 110) can be created. In one aspect, the preferences can pertain to how information is presented on a presentation component (e.g., presentation component 140) of user device 110. For example, the preferences can pertain to what information to present, what font size to present the information with, where on the presentation component should the information be presented, and the like. In another aspect, the preferences can include what applications or software to run on a device. Further, the preferences can include operation “rules” for the user device. The “rules” can include “rules” regarding operation of the user device based upon a determined location, e.g., a user wants the user device to operate in a particular way when the user device is being employed at a particular location or activity, e.g., a theater. Other “rules” include rules based upon any information filtering to control information being presented on the presentation component. Notification “rules” can control how a user is to be notified when information is to available to be presented on the presentation component. Other “rules” can be employed, as identified and/or related to other concepts presented herein. “Rules” can be stored, generated, modified, etc., (e.g., at the “rules” component 160).

At 1420 identification of a user of the user device can be performed. User identification can be performed by identification component 450 and/or identification component 510, which can employ any of a plurality of identification techniques to facilitate identification of a user of user device. Such identification techniques include facial recognition, biometric modalities such as iris recognition, fingerprint, passcode, password, and the like. An identification component can operate in conjunction with an audio recognition component (e.g., audio recognition component 430) and an audio input component (audio input component 350), which can be employed to identify a person based upon identification technologies relating to audio signals, such as voice recognition.

At 1430, operation of the user device can be adjusted in accordance with the identified user and their preferences. Presentation settings (e.g., font size) for presenting information on user device can be employed that pertain to the identified user. “Rules” for operation of user device can be employed, in accordance with the identified user. Further, any applications (e.g., applications 470, 620, 1040) can be controlled based upon the identified user, where control includes executing, terminating, limited operation, and the like.

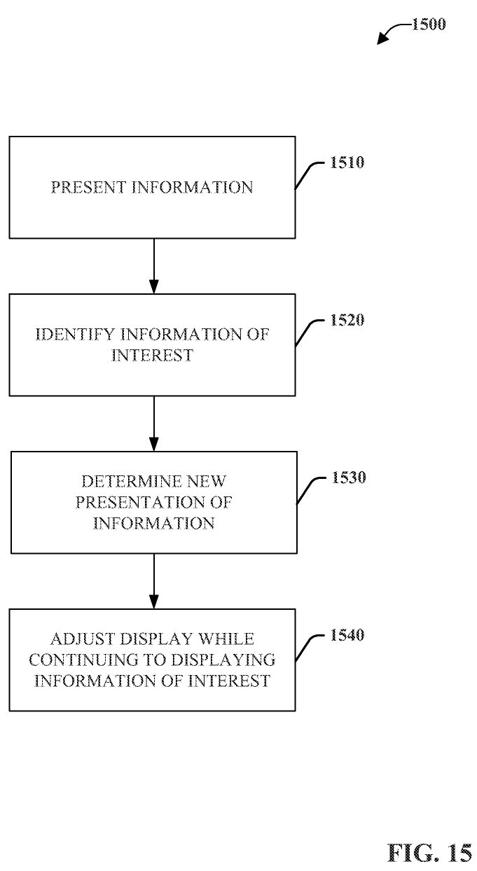

FIG. 15 illustrates methodology 1500 for presentation of information in accordance with operation of a context determination system. At 1510 information is presented on a user device (e.g., user device 110) via a presentation component (e.g., presentation component 140, presentation component(s) 640). In one aspect, operation of a user device employing a context determination system (e.g., context determination component 120, 1020) can involve information being presented in its entirety (e.g., a complete received text message, a complete webpage, map, and the like). In another aspect, a portion of the available information can be presented (e.g., text extracted by information extraction component 410, part of a webpage, and the like) by the presentation component. During context determination, how information is presented on the presentation component is adjusted in accordance with the context determination, e.g., in the case of presentation of text on a display device, text font size enlarges/reduces, as discussed supra. Adjustment of information can be performed by a presentation controller (e.g., presentation control component 130) in accordance with presentation parameters received from the context determination component.

A user may have an interest in a specific portion of the presented information. At 1520 the portion of interest can be identified. Identification can involve selecting the region of interest using a mouse or other pointer device, tracing out the area on a touchscreen, and the like. Alternatively, a single point of focus can be selected (e.g, by clicking a mouse, touching the screen, and the like). The selected region/point of focus can pertain to information of interest to a user, such that no matter what the employed font size, reduction and enlargement is performed such that that the region of interest is always presented (within the confines of font size) on the presentation component. In another aspect, as the information undergoes reduction/enlargement, reduction and enlargement is performed centered about the point of focus. The selected region/point of focus can be stored in a memory (e.g., memory 320).

At 1530, presentation of information is adjusted in accordance with the operation of the context determination system. For example, as a user is determined to be moving away from the presentation component, the font size employed to present information on the presentation equipment is enlarged. Accordingly, as the font size increases, there can be a corresponding reduction in the amount of information that can be presented on the presentation component.

At 1540, display of presented information can be adjusted to ensure that the region of interest is still displayed on the presentation component, or the reduction/enlargement of information (e.g., a webpage) is performed about the point of focus. Such approaches allow a person to view particular information over a wide range of viewing distances.

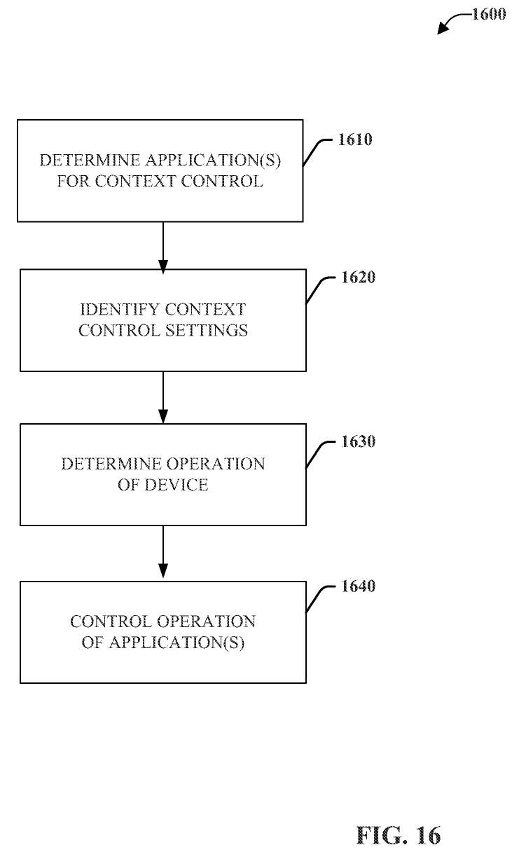

FIG. 16 illustrates a methodology 1600 facilitating control of application operation and presentation in a context determination system. Applications can include applications 470, 620, & 1040. At 1610, one or more applications are selected for control based upon determined context of operation of a user device (e.g., user device 110).

At 1620, one or more context control settings are identified for each of the applications. Context control settings can include, but not limited to, any of the following: control of which applications are to be operable based upon an identified user of the user device, control which applications to enable based upon location of the user device, control of the functionality available from a particular application, control of how an application presents information on a presentation component (e.g., presentation component 140, output components 640), control of what context triggers an application (e.g., acceleration triggering, velocity triggering, location triggering, etc.).

At 1630, context operation of the user device is determined. Context operation can be based on context determinations made by a context determination component (e.g., context component 120, 1020).

At 1640, based upon the determined context of operation, control of the various applications having an associated context-related control is performed based upon the context control settings.

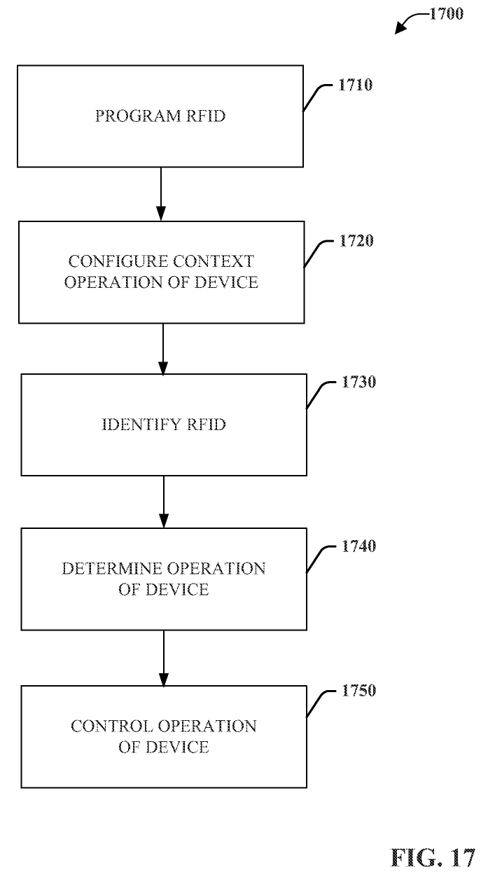

FIG. 17 illustrates a methodology 1700 facilitating context determination for operation of a user device (e.g., user device 110) based upon an associated RFID component, and subsequent operation of the user device based upon information received from the RFID e.g., context determination (by context determination component 120, 1020). At 1710, a RFID component (e.g., an RFID tag, RFID 540) is programmed with various data. Such data can include identification information of a person or object associated with the RFID component, preference settings regarding how a user device associated with the RFID component is to function, and the like.

At 1720 context operation of the user device is configured. Operation configuration can be in accordance with information stored on one or more RFID's. Configuration can, in one aspect, include whether a particular person or object associated with an RFID is allowed to operate the user device. In another aspect, configuration can relate to the functionality of one or more application(s) (e.g., applications 470, 620, 1070) operating on the user device. In a further aspect, configuration can relate to how information is to be presented on the user device (e.g., presentation component 140), e.g., when person x is detected, then employ a particular set of “context rules”, context algorithms, context score adjustments, and the like.

At 1730 upon an RFID component being brought within transmission range of the user device, the RFID component is identified by the user device. Transmission range can be affected by the type of RFID component, type of antenna(s) located on the RFID and the user device, environmental conditions, and the like.

At 1740, information is retrieve from the RFID by the user device. From the retrieved information, how the user device is to operate in accordance with the RFID information is determined. The retrieved information can be employed to determine whether a person is to be granted access to the user device, what application(s) to run on the user device, and the like. Further, the retrieved information can be employed to affect and effect context determination on the user device. Furthermore, the retrieved information can be employed to control how information is presented on the presentation component, e.g., the RFID owner is a doctor and particular patient information is to be presented.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

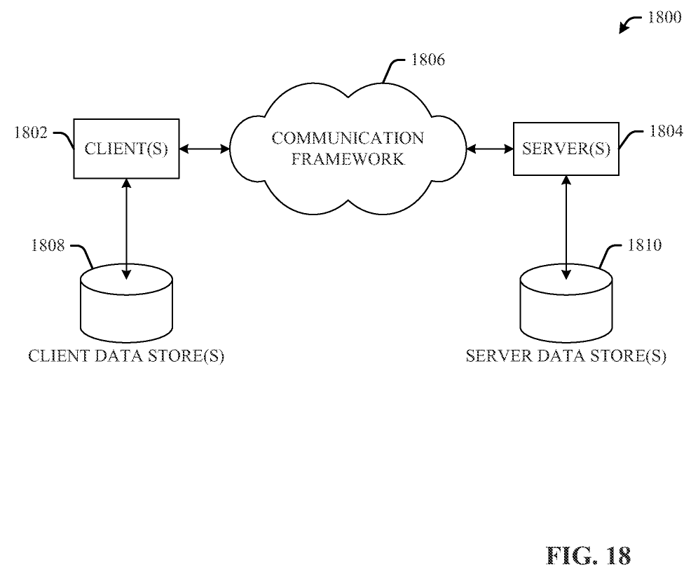

Referring now to FIG. 18, there is illustrated a schematic block diagram of a computing environment 1800 in accordance with the subject specification. The system 1800 includes one or more client(s) 1802. The client(s) 1802 can be hardware and/or software (e.g., threads, processes, computing devices). The client(s) 1802 can house cookie(s) and/or associated contextual information by employing the specification, for example.

The system 1800 also includes one or more server(s) 1804. The server(s) 1804 can also be hardware and/or software (e.g., threads, processes, computing devices). The servers 1804 can house threads to perform transformations by employing the specification, for example. One possible communication between a client 1802 and a server 1804 can be in the form of a data packet adapted to be transmitted between two or more computer processes. The data packet can include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

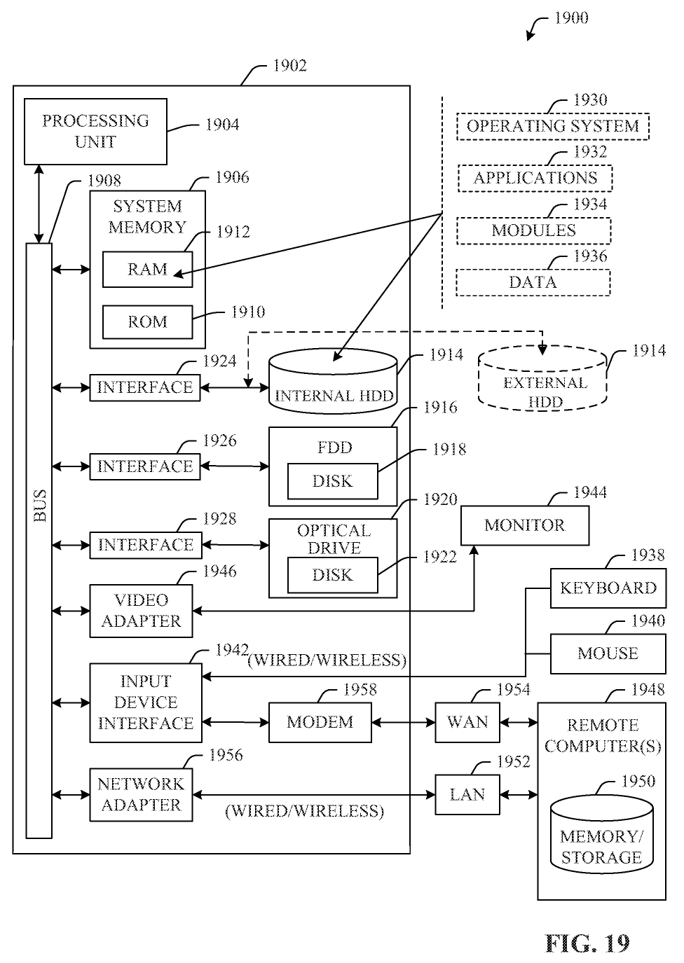

Referring now to FIG. 19, there is illustrated a block diagram of a computer operable to execute the disclosed architecture. In order to provide additional context for various aspects of the subject specification, FIG. 19 and the following discussion are intended to provide a brief, general description of a suitable computing environment 1900 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 19, the example environment 1900 for implementing various aspects of the specification includes a computer 1902, the computer 1902 including a processing unit 1904, a system memory 1906 and a system bus 1908. The system bus 1908 couples system components including, but not limited to, the system memory 1906 to the processing unit 1904. The processing unit 1904 can be any of various commercially available processors or proprietary specific configured processors. Dual microprocessors and other multi-processor architectures can also be employed as the processing unit 1904.

The system bus 1908 can be any of several types of bus structure that can further interconnect to a memory bus (with or without a memory controller), a peripheral bus, and a local bus using any of a variety of commercially available bus architectures. The system memory 1906 includes read-only memory (ROM) 1910 and random access memory (RAM) 1912. A basic input/output system (BIOS) is stored in a non-volatile memory 1910 such as ROM, EPROM, EEPROM, which BIOS contains the basic routines that help to transfer information between elements within the computer 1902, such as during start-up. The RAM 1912 can also include a high-speed RAM such as static RAM for caching data.

The computer 1902 further includes an internal hard disk drive (HDD) 1914 (e.g., EIDE, SATA), which internal hard disk drive 1914 can also be configured for external use in a suitable chassis (not shown), a magnetic floppy disk drive (FDD) 1916, (e.g., to read from or write to a removable diskette 1918) and an optical disk drive 1920, (e.g., reading a CD-ROM disk 1922 or, to read from or write to other high capacity optical media such as the DVD). The hard disk drive 1914, magnetic disk drive 1916 and optical disk drive 1920 can be connected to the system bus 1908 by a hard disk drive interface 1924, a magnetic disk drive interface 1926 and an optical drive interface 1928, respectively. The interface 1924 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1912, including an operating system 1930, one or more application programs 1932, other program modules 1934 and program data 1936. All or portions of the operating system, applications, modules, and/or data can also be cached in the RAM 1912. It is appreciated that the specification can be implemented with various proprietary or commercially available operating systems or combinations of operating systems.

A user can enter commands and information into the computer 1902 through one or more wired/wireless input devices, e.g., a keyboard 1938 and a pointing device, such as a mouse 1940. Other input devices (not shown) can include a microphone, an IR remote control, a joystick, a game pad, a stylus pen, touch screen, or the like. These and other input devices are often connected to the processing unit 1904 through an input device interface 1942 that is coupled to the system bus 1908, but can be connected by other interfaces, such as a parallel port, an IEEE 1394 serial port, a game port, a USB port, an IR interface, etc.

A monitor 1944 or other type of display device is also connected to the system bus 1908 via an interface, such as a video adapter 1946. In addition to the monitor 1944, a computer typically includes other peripheral output devices (not shown), such as speakers, printers, etc.

The computer 1902 can operate in a networked environment using logical connections via wired and/or wireless communications to one or more remote computers, such as a remote computer(s) 1948. The remote computer(s) 1948 can be a workstation, a server computer, a router, a personal computer, portable computer, microprocessor-based entertainment appliance, a peer device or other common network node, and typically includes many or all of the elements described relative to the computer 1902, although, for purposes of brevity, only a memory/storage device 1950 is illustrated. The logical connections depicted include wired/wireless connectivity to a local area network (LAN) 1952 and/or larger networks, e.g., a wide area network (WAN) 1954. Such LAN and WAN networking environments are commonplace in offices and companies, and facilitate enterprise-wide computer networks, such as intranets, all of which can connect to a global communications network, e.g., the Internet.

When used in a LAN networking environment, the computer 1902 is connected to the local network 1952 through a wired and/or wireless communication network interface or adapter 1956. The adapter 1956 can facilitate wired or wireless communication to the LAN 1952, which can also include a wireless access point disposed thereon for communicating with the wireless adapter 1956.

When used in a WAN networking environment, the computer 1902 can include a modem 1958, or is connected to a communications server on the WAN 1954, or has other means for establishing communications over the WAN 1954, such as by way of the Internet. The modem 1958, which can be internal or external and a wired or wireless device, is connected to the system bus 1908 via the input device interface 1942. In a networked environment, program modules depicted relative to the computer 1902, or portions thereof, can be stored in the remote memory/storage device 1950. It will be appreciated that the network connections shown are example and other means of establishing a communications link between the computers can be used.

The computer 1902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk'(DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for displaying information on a user device, comprising:
a context determination component that receives data regarding operation of the user device, determines context of operation of the user device, and generates presentation parameters for presentation of information on the user device; and
a presentation component which presents the information in accordance with the presentation parameters received from the presentation control component.

2. The system of claim 1, the context of operation of the user device relates to data received from at least one input component communicatively coupled to the context determination component.

3. The system of claim 2, the at least one input component is a proximity sensor, wherein the context determination component utilizes data received from the proximity sensor and determines a distance between a user and the user device.

4. The system of claim 3, the context determination component generates a presentation parameter controlling font size, wherein the font size value correlates to the determined distance.

5. The system of claim 2, the at least one input component is a motion sensing component, wherein the context determination component utilizes data received from the motion sensing component to determine motion of the user device.

6. The system of claim 5, the context determination component generates a presentation parameter controlling font size, wherein the font size value correlates to the determined motion of the user device.

7. The system of claim 1, the presentation parameters control at least one of font size, color, and placement of information presented on the presentation component.

8. The system of claim 1, the context determination component employs at least one rule to control information presentation.

9. The system of claim 1, the context determination component employs at least one algorithm to generate a context score.

10. The system of claim 7, the context score correlates with presentation parameters in a lookup table.

11. A method for presenting information based upon determined context of operation of a user device, comprising:
receiving data from at least one input component communicatively coupled to the user device;
determining, from the received data, a contextual operation of the user device;
generating at least one presentation parameter based upon the determined contextual operation;
controlling presentation of information on the user device in accordance with the at least one presentation parameter.

12. The method of claim 1, the at least one input component is a proximity sensor determining distance between the user device and a user of the user device.

13. The method of claim 12, generating a presentation parameter correlating to the determined distance, and presenting information in accordance with the presentation parameter.

14. The method of claim 13, determining whether the information can be presented in its entirety.

15. The method of claim 14, in the event of not being able to present the information in its entirety, extracting a portion of the information for presentation.

16. The method of claim 11, the at least one input component is a motion sensing component determining the degree of at least one of vibration, shock, acceleration affecting the user device.

17. The method of claim 16, generating a presentation parameter correlating to the determined degree of at least one of vibration, shock, or acceleration.

18. The method of claim 11, the presentation parameters control at least one of font size, color, and placement of presented information.

19. The system of claim 11, determining the contextual operation of the user device includes employing at least one algorithm for generating a context score.

20. A system for presenting information based upon determined context of operation of a user device, comprising a processor configured to:
receive data from at least one input component communicatively coupled to the user device;
determine from the received data, contextual operation of the user device;
generate at least one presentation parameter based upon the determined contextual operation;
control presentation of information on the user device in accordance with the at least one presentation parameter.
